(19) United States
(12) Patent Application Publication
(10) Pub. No.: US 2026/0285567 A1
(43) Pub. Date: Sep. 24, 2026

(54) MULTILAYER FILM STRUCTURES AND PACKAGES COMPRISING THE SAME

(71) Applicant: NOVA Chemicals (International) S.A., Fribourg (CH)

(72) Inventors: Marcia Pires Fortes Ferreira, Calgary (CA); Michael Li, Calgary (CA); Rosiane Rowlette, Englewood, FL (US); Daniel Ward, Maineville, OH (US)

(73) Assignee: NOVA Chemicals (International) S.A., Fribourg (CH)

(21) Appl. No.: 19/473,539

(22) PCT Filed: Apr. 5, 2024
(86) PCT No.: PCT/IB2024/053373

§ 371 Date: Oct. 8, 2025

Related U.S. Application Data
(60) Provisional application No. 63/496,247, filed on Apr. 14, 2023.

(51) Int. Cl. B65D 75/26; B32B 27/08; B32B 27/32; B65D 75/58; B65D 77/20

(52) U.S. Cl. CPC B65D 75/26; B32B 27/08; B32B 27/32; B65D 75/5855; B65D 77/2024; B32B 2250/242; B32B 2270/00; B32B 2307/31; B32B 2307/72; B32B 2307/748; B32B 2553/00

(57) ABSTRACT

A multilayer film structure comprising a sealant layer with a defined compositions and packages prepared from the multilayer film structure are disclosed. The sealant layer comprising from 5% to 65%, based on the total weight of the sealant layer, of a first ethylene copolymer composition; from 20% to 90%, based on the total weight of the sealant layer, of a second ethylene copolymer composition; and from 5% to 30%, based on the total weight of the sealant layer, of a polybutene-1 resin; wherein the first ethylene copolymer composition has a density of from greater than 0.910 g/cm³ to less than or equal to 0.940 g/cm³ and a melt index I₂ of from 3.0 dg/min to 7.0 dg/min, and wherein the second ethylene copolymer composition has a density of from greater than or equal to 0.865 g/cm³ to less than or equal to 0.910 g/cm³.

### TECHNICAL FIELD

The present disclosure relates to multilayer film structures having a defined sealant layer composition and packages prepared therefrom.

### BACKGROUND ART

A heat sealable film structure is a mono or multilayer structure which is capable of forming a bond when, in a partially molten state, brought into intimate contact with itself or a substrate (e.g., another film structure or a rigid/semirigid structure). Based on the functional requirements, heat sealing process variables and heat sealable film structures can be designed to yield two types of bond strength; namely: lockup seals and peelable seals. Lockup seals are preferred in hermetic sealing applications and peelable seals are preferable in applications involving easy-to-open packaging systems. While the magnitude of opening forces that are deemed to be easy to open depends on the target user group for a particular packaged product, the desired seal strength of peelable seals for easy-to-open applications in packaged food items is generally in the range of less than about 15 N per 25.4 mm of seal width and greater than about 3.9 per 25.4 mm of seal width. Commonly known technologies for easy-to-open seals include cohesive peels, adhesive peels and delamination peels. In cohesive peel systems, the sealant layer is prepared from a blend of a polymer matrix and a dispersed phase of an incompatible polymer. Common blend compositions used in cohesive peel systems include polymer matrixes produced in high-pressure polymerization processes—examples of which include low-density polyethylenes (LDPEs) or ethylene-vinyl acetate (EVA) copolymers—and a polybutene-1 resin dispersed phase.

### SUMMARY OF INVENTION

Provided in a first aspect is a multilayer film structure, comprising a sealant layer, the sealant layer comprising: from 5% to 65%, based on the total weight of the sealant layer, of a first ethylene copolymer composition; from 20% to 90%, based on the total weight of the sealant layer, of a second ethylene copolymer composition; and from 5% to 30%, based on the total weight of the sealant layer, of a polybutene-1 resin; wherein the first ethylene copolymer composition has a density of from greater than 0.910 g/cm³ to less than or equal to 0.940 g/cm³ and a melt index I₂ of from 3 dg/min to 7 dg/min, and wherein the second ethylene copolymer composition has a density of from greater than or equal to 0.865 g/cm³ to less than or equal to 0.910 g/cm³.

In some embodiments, the multilayer film structure further comprises a sublayer, the sublayer comprising a high density polyethylene resin having a density of greater than or equal to 0.945 g/cm³ and a melt index I₂ of from 0.1 to 10 dg/min.

In some embodiments, the sublayer is in adhering contact with a bottom surface of the sealant layer.

In some embodiments, the polybutene-1 resin is a butene-1 homopolymer.

In some embodiments, the polybutene-1 resin is a butene-1/ethylene copolymer.

In some embodiments, the sealant layer comprises from 5% to 50%, based on the total weight of the sealant layer, of the first ethylene copolymer composition; from 30% to 90%, based on the total weight of the sealant layer, of the second ethylene copolymer composition; and from 5% to 25%, based on the total weight of the sealant layer, of the polybutene-1 resin.

In some embodiments, the sealant layer comprises from 5% to 50%, based on the total weight of the sealant layer, of the first ethylene copolymer composition; from 30% to 90%, based on the total weight of the sealant layer, of the second ethylene copolymer composition; and from 5% to 20%, based on the total weight of the sealant layer, of the polybutene-1 resin.

In some embodiments, the first ethylene copolymer composition has a melt index I₂ of from 3.5 dg/min to 6 dg/min.

In some embodiments, the first ethylene copolymer composition has a density of from greater than or equal to 0.912 g/cm³ to less than or equal to 0.935 g/cm³. In some embodiments, the first ethylene copolymer composition has a density of from greater than or equal to 0.912 g/cm³ to less than or equal to 0.930 g/cm³. In some embodiments, the first ethylene copolymer composition comprises a fraction eluting at a temperature range of from 90° C. to 105° C. having an integrated area of less than or equal to 20 weight percent, in a CTREF analysis.

In some embodiments, the first ethylene copolymer composition contains undetectable levels of long chain branches as determined according to a long chain branching factor, LCBF, of less than 0.001.

In some embodiments, the first ethylene copolymer composition contains detectable levels of long chain branches as determined according to a long chain branching factor, LCBF, of greater than 0.001.

In some embodiments, the first ethylene copolymer composition has a molecular weight distribution M_{w}/Mₙ of greater than or equal to 1.7 to less than or equal to 5.

In some embodiments, the first ethylene copolymer composition is an ethylene/octene-1 copolymer composition.

In some embodiments, the second ethylene copolymer composition has a melt index I₂ of from 0.5 dg/min to 1.5 dg/min.

In some embodiments, the second ethylene copolymer composition has a melt index I₂ of from 0.7 dg/min to 1.2 dg/min.

In some embodiments, the second ethylene copolymer composition has a density of from greater than or equal to 0.890 g/cm³ to less than or equal to 0.910 g/cm³.

In some embodiments, the second ethylene copolymer composition has a density of from greater than or equal to 0.900 g/cm³ to less than or equal to 0.910 g/cm³.

In some embodiments, the second ethylene copolymer composition comprises a fraction eluting at a temperature range of from 90° C. to 105° C. having an integrated area of less than 1 weight percent, in a CTREF analysis.

In some embodiments, the second ethylene copolymer composition has a molecular weight distribution M_{w}/Mₙ of greater than or equal to 1.7 to less than or equal to 4.

In some embodiments, the second ethylene copolymer composition has a molecular weight distribution M_{w}/Mₙ of greater than or equal to 1.7 to less than or equal to 3.5.

In some embodiments, the second ethylene copolymer composition contains detectable levels of long chain branches as determined according to a long chain branching factor, LCBF, of greater than or equal to 0.001.

In some embodiments, the second ethylene copolymer composition is an ethylene/octene-1 copolymer composition.

In some embodiments, the high density polyethylene resin comprises a blend of at least two ethylene homopolymer blend components; the blend comprising: from 30 to 95 weight percent of a first ethylene homopolymer blend component having a density of from 0.950 to 0.975 g/cm³; and from 5 to 70 weight parent of a second ethylene homopolymer blend component having a density of from 0.950 to 0.975 g/cm³; wherein the ratio of the melt index I₂ of the second ethylene homopolymer blend component to the melt index 12 of the first ethylene homopolymer blend component is at least 10.

In some embodiments, the high density polyethylene resin comprises from 100 to 3000 parts per million of a nucleating agent or a mixture of nucleating agents.

In some embodiments, the high density polyethylene resin has a polydispersity index M_{w}/Mₙ of from 7 to 18.

In some embodiments, the high density polyethylene resin essentially consists of a nucleating agent; and a blend of two ethylene homopolymer blend components, the blend consists of: from 30 to 95 weight percent of a first ethylene homopolymer blend component having a density of from 0.950 to 0.975 g/cm³; and from 5 to 70 weight parent of a second ethylene homopolymer blend component having a density of from 0.950 to 0.975 g/cm³; wherein the ratio of the melt index I₂ of the second ethylene homopolymer blend component to the melt index I₂ of the first ethylene homopolymer blend component is at least 10.

In some embodiments, the nucleating agent is present in amount from 100 to 3000 parts per million.

In some embodiments, the high density polyethylene resin has a polydispersity index M_{w}/Mₙ of from 7 to 18.

In some embodiments, the multilayer film has from 3 to 11 layers.

In some embodiments, the multilayer film structure is an all-polyethylene multilayer film structure.

In some embodiments, the multilayer film structure has a seal initiation temperature, SIT, of less than or equal to 115° C., wherein SIT is the minimum sealing temperature at which the film structure has a seal strength of greater than 3.9 N per 25.4 mm of seal width.

In some embodiments, the multilayer film structure has a hot tack onset temperature of less than or equal to 110° C., wherein the hot tack onset temperature is the minimum sealing temperature at which the film structure has a hot tack force of greater than 1.0 N.

In some embodiments, the multilayer film structure has a hot tack window of greater than or equal to 20° C., wherein the hot tack window is a range of sealing temperature in which the multilayer film structure has a hot tack force of greater than 2.5 N.

In some embodiments, the multilayer film structure has a seal strength of less than 11 N per 25.4 mm of seal width at a at a sealing temperature of from SIT to SIT+25° C.

Provided in a second aspect is a package comprising the multilayer film structure as defined in the first aspect.

In some embodiments, a first section of a top surface of the sealant layer is heat sealed to a second section of the top surface of the sealant layer to form a peelable seal.

In some embodiments, the peelable seal has a peel initiation force of from 2 N to 15 N at a sealing temperature of from 110° C. to 125° C.

In some embodiments, the peelable seal has a peel propagation force of from 1 N to 6 N at a sealing temperature of from 110° C. to 125° C.

In some embodiments, the package further comprises a tray, and wherein a first section of a top surface of the sealant layer is heat sealed to the tray to form a peelable seal.

### BRIEF DESCRIPTION OF DRAWINGS

FIG. 1 shows the hot tack profiles for the multilayer film structures prepared in Structures 1-3 and Comparative Structures 1-2. Error bars indicate the ±standard deviation range for five seal strength measurements at each sealing temperature.

FIG. 2a-2e illustrate the seal strength profiles of the multilayer film structures prepared in Structures 1-3, Structure 1A and Comparative Structures 1-2 conditioned under the ASTM conditions at different duration of times. Dotted horizontal lines represent the upper and lower limits of the seal strength range of from 3.9 to 11 N/25.4 mm. Error bars indicate the ±standard deviation range for five seal strength measurements at each sealing temperature.

FIG. 3 shows the hot tack profiles for the nine-layer structures prepared in Structures 4-7 and Comparative Structures 3-4. Error bars indicate the ±standard deviation range for five seal strength measurements at each sealing temperature.

FIG. 4 illustrate the seal strength profiles of the nine-layer structures prepared in Structures 4-7 and Comparative Structures 3-4 conditioned for 24 h under the ASTM conditions. Dotted horizontal lines represent the upper and lower limits of the seal strength range of from 3.9 to 11 N/25.4 mm. Error bars indicate the ±standard deviation range for five seal strength measurements at each sealing temperature.

### DEFINITION OF TERMS

Other than in the examples or where otherwise indicated, all numbers or expressions referring to quantities of ingredients, extrusion conditions, etc., used in the specification and claims are to be understood as modified in all instances by the term “about”. Accordingly, unless indicated to the contrary, the numerical parameters set forth in the following specification and attached claims are approximations that can vary depending upon the desired properties that the various embodiments desire to obtain. At the very least, and not as an attempt to limit the application of the doctrine of equivalents to the scope of the claims, each numerical parameter should at least be construed in light of the number of reported significant digits and by applying ordinary rounding techniques. The numerical values set forth in the specific examples are reported as precisely as possible. Any numerical values, however, inherently contain certain errors necessarily resulting from the standard deviation found in their respective testing measurements.

It should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

All compositional ranges expressed herein are limited in total to and do not exceed 100 percent (volume percent or weight percent) in practice. Where multiple components can be present in a composition, the sum of the maximum amounts of each component can exceed 100 percent, with the understanding that, and as those skilled in the art readily understand, that the amounts of the components actually used will conform to the maximum of 100 percent.

In order to form a more complete understanding of this disclosure the following terms are defined and should be used with the accompanying figures and the description of the various embodiments throughout.

As used herein, the term “monomer” refers to a small molecule that may chemically react and become chemically bonded with itself or other monomers to form a polymer. As used herein, the term “α-olefin” or “alpha-olefin” is used to describe a monomer having a linear hydrocarbon chain having a double bond at one end of the chain and containing from n=3 to 20 carbon atoms with a chemical formula CₙH₂ₙ; an equivalent term is “linear α-olefin”.

As used herein, the terms “polyethylene”, “polyethylene polymer” or “ethylene polymer”, refers to macromolecules produced from ethylene monomer and optionally at least one α-olefin monomer; regardless of the specific catalyst or specific process used to make the ethylene polymer. An ethylene polymer in its polymerized form will include greater than 50 weight percent (based on the weight of the ethylene polymer) of ethylene monomeric units. Common polyethylenes include high density polyethylene (HDPE), medium density polyethylene (MDPE), low density polyethylene (LDPE), linear low density polyethylene (LLDPE), very low density polyethylene (VLDPE), ultralow density polyethylene (ULDPE), plastomer and elastomers. The term polyethylene also includes combinations of, or blends of, the polyethylenes described above.

As used herein, the term “ethylene homopolymer” refers to a subset of polymers within the “ethylene polymer” group that are produced using only ethylene as a polymerizable monomer.

As used herein, the term “ethylene copolymer” refers to a subset of polymers within the “ethylene polymer” group that are produced from ethylene and at least one α-olefin and excludes ethylene polymers produced in high-pressure polymerization processes—examples of ethylene polymers produced in high-pressure polymerization processes include low-density polyethylenes (LDPEs) or ethylene-vinyl acetate (EVA) copolymers.

The term “thermoplastic polymer” refers to a polymer that becomes liquid when heated, will flow under pressure and solidify when cooled. Thermoplastic polymers include ethylene polymers as well as other polymers used in the plastic industry; non-limiting examples of other polymers commonly used in film applications include barrier resins (e.g., EVOH), tie resins, polyethylene terephthalate (PET), polyamides, ethylene-vinyl acetate copolymers (EVA) and the like.

As used herein, the terms “sheet” and “film” refer to a web of material of any thickness.

As used herein the term “monolayer film” refers to a film containing a single layer of one or more than one thermoplastic polymer.

As used herein the term “multilayer film” or “multilayer film structure” refers to a film composed of more than one thermoplastic layer, or optionally non-thermoplastic layers. Non-limiting examples of non-thermoplastic materials include metals (foil) or cellulosic (paper) products. One or more of the thermoplastic layers within a multilayer film (or film structure) may be comprised of more than one thermoplastic.

As used herein, the term “all-polyethylene multilayer film structure” refers to a multilayer film structure containing greater than or equal to 90% of one or more than one ethylene polymer based on the total weight of the multilayer film structure excluding the non-thermoplastic layers (if present).

As used herein, the term “sealant layer” refers to a layer of thermoplastic film that is capable of being bonded to itself or a substrate (e.g., another film or a rigid/semirigid structure), forming a leak proof seal. A “sealant layer” may be a skin layer or the innermost layer in a multilayer film structure.

As used herein, the term “peelable seal” refers to a seal formed by a sealant layer which is strong enough to form a leak proof seal, but the seal can be separated with no substantial breaking, tearing or elongation of the thermoplastic film(s) and the substrate (if present).

As used herein, the term “easy-opening” or “easy-to-open” refers to a peelable seal which may be readily manually separated by a consumer. While the magnitude of opening forces that are deemed to be easy to open depends on the target user group for a particular packaged product, the desired seal strength of peelable seals for easy-to-open applications in packaged food items is generally in the range of less than about 15 N per 25.4 mm of seal width and greater than about 3.9 per 25.4 mm of seal width, or preferably in in the range of less than about 11 N per 25.4 mm of seal width and greater than about 3.9 per 25.4 mm of seal width.

As used herein, the term “adhesive lamination” and the term “extrusion lamination” describes continuous processes through which two or more substrates, or webs of material, are combined to form a multilayer product or sheet; wherein the two or more webs are joined using an adhesive or a molten thermoplastic film, respectively.

As used herein, the term “extrusion coating” describes a continuous process through which a molten thermoplastic layer is combined with, or deposited on, a moving solid web or substrate. Non-limiting examples of substrates include paper, paperboard, foil, monolayer plastic film, multilayer plastic film or fabric. The molten thermoplastic layer could be monolayer or multilayer.

### DESCRIPTION OF EMBODIMENTS

In the present disclosure, the multilayer film structure will include a sealant layer. The sealant layer includes a first ethylene copolymer composition; a second ethylene copolymer composition; and a polybutene-1 resin. In some embodiments, the multilayer film structure further includes a high density sublayer.

### Sealant Layer

The sealant layer comprises from 5% to 65%, based on the total weight of the sealant layer, of a first ethylene copolymer composition; from 20% to 90%, based on the total weight of the sealant layer, of a second ethylene copolymer composition; and from 5% to 30%, based on the total weight of the sealant layer, of a polybutene-1 resin.

In some embodiments, the sealant layer comprises from 5% to 50%, based on the total weight of the sealant layer, of a first ethylene copolymer composition; from 30% to 90%, based on the total weight of the sealant layer, of a second ethylene copolymer composition; and from 5% to 25%, based on the total weight of the sealant layer, of a polybutene-1 resin.

In some embodiments, the sealant layer comprises from 5% to 50%, based on the total weight of the sealant layer, of a first ethylene copolymer composition; from 30% to 90%, based on the total weight of the sealant layer, of a second ethylene copolymer composition; and from 5% to 20%, based on the total weight of the sealant layer, of a polybutene-1 resin.

In some embodiments, the sealant layer comprises from 25% to 50%, based on the total weight of the sealant layer, of a first ethylene copolymer composition; from 30% to 90%, based on the total weight of the sealant layer, of a second ethylene copolymer composition; and from 5% to 20%, based on the total weight of the sealant layer, of a polybutene-1 resin.

In some embodiments, the first ethylene copolymer composition has a density of from greater than 0.910 g/cm³ to less than or equal to 0.940 g/cm³, or from greater than or equal to 0.912 g/cm³ to less than or equal to 0.935 g/cm³, or from greater than or equal to 0.912 g/cm³ to less than or equal to 0.930 g/cm³.

In some embodiments, the first ethylene copolymer composition has a melt index I₂ of from 3 dg/min to 7 dg/min, or preferably from 3.5 dg/min to 6 dg/min.

In embodiments of the disclosure, the first ethylene copolymer composition can be made using a gas-phase, a solution-phase, or a slurry polymerization processes, or any combination thereof, using any type of reactor or reactor configuration known in the art, e.g., fluidized bed gas phase reactors, loop reactors, stirred tank reactors, batch reactors in parallel, series, and/or any combinations thereof.

In an embodiment of the disclosure, the first ethylene copolymer composition is made in a coordination polymerization process using a catalyst.

In an embodiment of the disclosure, the first ethylene copolymer composition is made in a solution phase coordination polymerization process using a catalyst.

In an embodiment of the disclosure, the first ethylene copolymer composition is made with a Ziegler-Natta catalyst.

In an embodiment of the disclosure, the first ethylene copolymer composition is made with a Ziegler-Natta catalyst in a solution phase polymerization process.

In an embodiment of the disclosure, the first ethylene copolymer composition is made with a homogenous catalyst. Non-limiting examples of homogeneous catalysts are metallocene catalysts, constrained geometry catalysts, and phosphinimine catalysts.

In an embodiment of the disclosure, the first ethylene copolymer composition is made in a solution phase polymerization process with a homogenous catalyst.

In an embodiment of the disclosure, the first ethylene copolymer composition is made with a phosphinimine catalyst.

In an embodiment of the disclosure, the first ethylene copolymer composition is made with a phosphinimine catalyst in a solution phase polymerization process.

In an embodiment of the disclosure, the first ethylene copolymer composition is made with a metallocene catalyst.

In an embodiment of the disclosure, the first ethylene copolymer composition is made with a metallocene catalyst in a solution phase polymerization process.

In an embodiment of the disclosure, the first ethylene copolymer composition is made with a phosphinimine catalyst and a Ziegler-Natta catalyst.

In an embodiment of the disclosure, the first ethylene copolymer composition is made with a phosphinimine catalyst and a Ziegler-Natta catalyst in a solution phase polymerization process.

In an embodiment of the disclosure, the first ethylene copolymer composition is made with a metallocene catalyst and a Ziegler-Natta catalyst.

In an embodiment of the disclosure, the first ethylene copolymer composition is made with a metallocene catalyst and a Ziegler-Natta catalyst in a solution phase polymerization process.

In embodiments of the disclosure, the first ethylene copolymer composition has a molecular weight distribution, M_{w}/Mₙ of greater than or equal to 1.7 to less than or equal to 5, or from greater than or equal to 2 to less than or equal to 5, or from greater than or equal to 2.0 to less than or equal to 4.5, or from greater than or equal to 2 to less than or equal to 4.0. In still further embodiments of the disclosure, the first ethylene copolymer composition has a M_{w}/Mₙ ratio of from greater than or equal to 3 to less than or equal to 5.5, or from greater than or equal to 3.0 to less than or equal to 4.5, or from greater than or equal to 3 to less than or equal to 4.0, or from greater than or equal to 3.2 to less than or equal to 5.5, or from greater than or equal to 3.2 to less than or equal to 5.

In embodiments of the disclosure, the first ethylene copolymer composition contains undetectable levels of long chain branches as determined according to a long chain branching factor, LCBF, of less than 0.001.

In embodiments of the disclosure, the first ethylene copolymer composition contains detectable levels of long chain branches as determined according to a long chain branching factor, LCBF, of greater than 0.001.

In embodiments of the disclosure, the first ethylene copolymer composition comprises at least one C₃-C₂₀ α-olefin.

In embodiments of the disclosure, the first ethylene copolymer composition comprises at least one of butene-1, hexene-1 and octene-1.

In embodiments of the disclosure, the first ethylene copolymer composition comprises at least one of butene-land octene-1.

In an embodiment of the disclosure, the first ethylene copolymer composition is an ethylene/butene-1 copolymer composition.

In an embodiment of the disclosure, the first ethylene copolymer composition is an ethylene/hexene-1 copolymer composition.

In an embodiment of the disclosure, the first ethylene copolymer composition is an ethylene/octene-1 copolymer composition.

In embodiments of the disclosure, the first ethylene copolymer composition comprises at least one C₃-C₂₀ α-olefin and comprises at least 70 weight percent of ethylene, or at least 80 weight percent of ethylene, or at least 90 weight percent of ethylene.

In embodiments of the disclosure, the first ethylene copolymer composition is an ethylene/butene-1 copolymer composition and comprises at least 70 weight percent of ethylene, or at least 80 weight percent of ethylene, or at least 90 weight percent of ethylene.

In embodiments of the disclosure, the first ethylene copolymer composition is an ethylene/hexene-1 copolymer composition and comprises at least 70 weight percent of ethylene, or at least 80 weight percent of ethylene, or at least 90 weight percent of ethylene.

In embodiments of the disclosure, the first ethylene copolymer composition is an ethylene/octene-1 copolymer composition and comprises at least 70 weight percent of ethylene, or at least 80 weight percent of ethylene, or at least 90 weight percent of ethylene.

In embodiments of the disclosure, the first ethylene copolymer composition comprises a fraction eluting at a temperature range of from 90° C. to 105° C. having an integrated area of less than or equal to 20 weight percent, in a CTREF analysis.

In embodiments of the disclosure, the first ethylene copolymer composition comprises a fraction eluting at a temperature range of from 90° C. to 105° C. having an integrated area of less than or equal to 18 weight percent, in a CTREF analysis.

In embodiments of the disclosure, the first ethylene copolymer composition has a CDBI₅₀ of from 50 to 85 wt % (weight percent), or from 60 to 85 wt %, or from 60 to about 80 wt %, or from 60 to about 75 wt %, or from about 50 to about 80 wt %, or from about 50 to about 75 wt %, or from about 55 to about 80 wt %, or from about 55 to about 75 wt %.

In some embodiments, the second ethylene copolymer composition has a density of from greater than or equal to 0.865 g/cm³ to less than or equal to 0.910 g/cm³, or from greater than or equal to 0.890 g/cm³ to less than or equal to 0.910 g/cm³, or from greater than or equal to 0.900 g/cm³ to less than or equal to 0.910 g/cm³.

In some embodiments, the second ethylene copolymer composition has a melt index I₂ of from 0.5 dg/min to 1.5 dg/min or from 0.7 dg/min to 1.2 dg/min.

In some embodiments, the second ethylene copolymer composition comprises a fraction eluting at a temperature range of from 90° C. to 105° C. having an integrated area of less than 12 weight percent, in a CTREF analysis.

In some embodiments, the second ethylene copolymer composition comprises a fraction eluting at a temperature range of from 90° C. to 105° C. having an integrated area of less than 4 weight percent, in a CTREF analysis.

In some embodiments, the second ethylene copolymer composition comprises a fraction eluting at a temperature range of from 90° C. to 105° C. having an integrated area of less than 2 weight percent, in a CTREF analysis.

In some embodiments, the second ethylene copolymer composition comprises a fraction eluting at a temperature range of from 90° C. to 105° C. having an integrated area of less than 1 weight percent, in a CTREF analysis.

In some embodiments, the second ethylene copolymer composition comprises a fraction eluting at a temperature range of from 90° C. to 105° C. having an integrated area of less than 0.5 weight percent, in a CTREF analysis.

In embodiments of the disclosure, the second ethylene copolymer composition has a CDBI₅₀ of from 80 to 98 wt % (weight percent), or from 85 to 98 wt %, or from 85 to about 95 wt %.

In embodiments of the disclosure, the second ethylene copolymer composition has a molecular weight distribution (M_{w}/Mₙ) of from 1.7 to 4, or from 1.7 to 3.7, or from 1.7 to 3.5, or from 2.1 to 4, or from 2.1 to 3.7, or from 2.1 to 3.5, or from 2.5 to 4, or from 2.5 to 3.7, or from 2.5 to 3.5. In some embodiments, the ethylene polymer composition has a molecular weight distribution (M_{w}/Mₙ) of from 2 to 4.

In embodiments of the disclosure, the second ethylene copolymer composition comprises at least one C₃-C₂₀ α-olefin.

In embodiments of the disclosure, the second ethylene copolymer composition comprises at least one of butene-1, hexene-1 and octene-1.

In an embodiment of the disclosure, the second ethylene copolymer composition is an ethylene/octene-1 copolymer composition.

In embodiments of the disclosure, the second ethylene copolymer composition comprises at least one C₃-C₂₀ α-olefin and comprises at least 60 weight percent of ethylene, or at least 70 weight percent of ethylene, or at least 80 weight percent of ethylene.

In embodiments of the disclosure, the second ethylene copolymer composition is an ethylene/octene-1 copolymer composition and comprises at least 60 weight percent of ethylene, or at least 70 weight percent of ethylene, or at least 80 weight percent of ethylene.

In some embodiments, the second ethylene copolymer composition contains detectable levels of long chain branches as determined according to a long chain branching factor, LCBF, of greater than or equal to 0.001.

In some embodiment, the second ethylene copolymer composition contains detectable levels of long chain branches as determined according to a long chain branching factor, LCBF, of greater than or equal to 0.001 and less than or equal to 0.1.

In some embodiment, the second ethylene copolymer composition contains detectable levels of long chain branches as determined according to a long chain branching factor, LCBF, of greater than or equal to 0.001 and less than or equal to 0.05.

In embodiments of the disclosure, the second ethylene copolymer composition can be made using a gas-phase, a solution-phase, or a slurry polymerization processes, or any combination thereof, using any type of reactor or reactor configuration known in the art, e.g., fluidized bed gas phase reactors, loop reactors, stirred tank reactors, batch reactors in parallel, series, and/or any combinations thereof.

In an embodiment of the disclosure, the second ethylene copolymer composition is made in a coordination polymerization process using a catalyst.

In an embodiment of the disclosure, the second ethylene copolymer composition is made in a solution phase coordination polymerization process using a catalyst.

In an embodiment of the disclosure, the second ethylene copolymer composition is made with a homogenous catalyst. Non-limiting examples of homogeneous catalysts are metallocene catalysts, constrained geometry catalysts, and phosphinimine catalysts.

In an embodiment of the disclosure, the second ethylene copolymer composition is made in a solution phase polymerization process with a homogenous catalyst.

In an embodiment of the disclosure, the second ethylene copolymer composition is made in a solution phase polymerization process with a homogenous catalyst.

In an embodiment of the disclosure, the second ethylene copolymer composition is made with a phosphinimine catalyst.

In an embodiment of the disclosure, the second ethylene copolymer composition is made with a phosphinimine catalyst in a solution phase polymerization process.

In an embodiment of the disclosure, the second ethylene copolymer composition is made with a metallocene catalyst.

In an embodiment of the disclosure, the second ethylene copolymer composition is made with a metallocene catalyst in a solution phase polymerization process.

In an embodiment of the disclosure, the second ethylene copolymer composition is made with a phosphinimine catalyst and a Ziegler-Natta catalyst.

In an embodiment of the disclosure, the second ethylene copolymer composition is made with a phosphinimine catalyst and a Ziegler-Natta catalyst in a solution phase polymerization process.

In an embodiment of the disclosure, the second ethylene copolymer composition is made with a metallocene catalyst and a Ziegler-Natta catalyst.

In an embodiment of the disclosure, the second ethylene copolymer composition is made with a metallocene catalyst and a Ziegler-Natta catalyst in a solution phase polymerization process.

In embodiments of the disclosure, the first ethylene copolymer composition and/or the second ethylene copolymer composition may contain conventional type additives, including (1) primary antioxidants (such as for example, hindered phenols, including vitamin E); (2) secondary antioxidants (such as for example, phosphites and phosphonites); and (3) process aids (such as for example, fluoroelastomer and/or polyethylene glycol bound process aid).

Still other additives that may be added to the first ethylene copolymer composition and/or the second ethylene copolymer composition in embodiments of the disclosure include nitrones, antacids, UV absorbers, metal deactivators, pigments, dyes, fillers and reinforcing agents, nano-scale organic or inorganic materials, antistatic agents, lubricating agents such as calcium stearates, and slip additives such as erucamide and behenamide. The polybutene-1 resin can be a butene-1 homopolymer or a butene-1 copolymer.

In some embodiments, the polybutene-1 resin has a melt index I₂ of from 0.1 dg/min to 50 dg/min, or from 0.1 dg/min to 20 dg/min, or from 0.1 dg/min to 10 dg/min, or from 0.3 dg/min to 10 dg/min or from 0.4 dg/min to 5 dg/min.

In some embodiments, the polybutene-1 resin has a density of from 0.875 g/cm³ to 0.925 g/cm³, or preferably from 0.890 g/cm³ to 0.920 g/cm³.

In some embodiments, the polybutene-1 resin is a butene-1 homopolymer.

In some embodiments, the polybutene-1 resin is a butene-1/ethylene copolymer.

### Sublayer

The multilayer film structure may further include a high density sublayer. The high density sublayer comprises a high density polyethylene resin having a density of greater than or equal to 0.945 g/cm³ and a melt index I₂ of from 0.1 to 10 dg/min.

In some embodiments, the sublayer is in adhering contact with a bottom surface of the sealant layer.

In embodiments of the disclosure, a high density polyethylene has a density of greater than or equal to 0.940 g/cm³, or greater than or equal to 0.941 g/cm³, or greater than or equal to 0.945 g/cm³, or greater than or equal to 0.949 g/cm³, or greater than or equal to 0.950 g/cm³, or greater than or equal to 0.955 g/cm³, or greater than or equal to 0.960 g/cm³, or greater than or equal to 0.965 g/cm³.

In embodiments of the disclosure, a high density polyethylene has a density of from greater than or equal to 0.945 to less than or equal to 0.975 g/cm³, or from greater than or equal to 0.945 to less than or equal to 0.970 g/cm³, or from greater than or equal to 0.945 to less than or equal to 0.967 g/cm³, or from greater than or equal to 0.949 to less than or equal to 0.975 g/cm³, or from greater than or equal to 0.949 to less than or equal to 0.970 g/cm³, or from greater than or equal to 0.949 to less than or equal to 0.967 g/cm³, or from greater than or equal to 0.950 to less than or equal to 0.975 g/cm³, or from greater than or equal to 0.950 to less than or equal to 0.970 g/cm³, or from greater than or equal to 0.950 to less than or equal to 0.967 g/cm³, or from greater than or equal to 0.955 to less than or equal to 0.975 g/cm³, or from greater than or equal to 0.955 to less than or equal to 0.970 g/cm³, or from greater than or equal to 0.955 to less than or equal to 0.967 g/cm³, or from greater than or equal to 0.960 to less than or equal to 0.975 g/cm³, or from greater than or equal to 0.960 to less than or equal to 0.970 g/cm³, or from greater than or equal to 0.960 to less than or equal to 0.967 g/cm³.

In embodiments of the disclosure, a high density polyethylene has a melt index, 12 of from 0.01 to 100 dg/min, or from 0.1 to 50 dg/min, or from 0.1 to 10 dg/min, or from 0.1 to 8 dg/min, or from 0.5 to 10 dg/min, or from 0.8 to 8 dg/min, or from 0.5 to 8 dg/min, or from 0.1 to 5 dg/min, or from 0.5 to 5 dg/min.

In embodiments of the disclosure, the high density polyethylene can be unimodal, or bimodal, or multimodal. The term “unimodal” is herein defined to mean there will be only one significant peak or maximum evident in a GPC curve. A unimodal profile includes a broad unimodal profile. In contrast, the use of the term “bimodal” is meant to convey that in addition to a first peak, there will be a secondary peak or shoulder which represents a higher or lower molecular weight component—i.e., the molecular weight distribution curve can be said to have two maxima. Alternatively, the term “bimodal” connotes the presence of two maxima in a molecular weight distribution curve. The term “multi-modal” denotes the presence of two or more, typically more than two, maxima in a molecular weight distribution curve.

In an embodiment of the disclosure, a high density polyethylene has a molecular weight distribution, M_{w}/Mₙ of from about 3 to about 20.

In an embodiment of the disclosure, a high density polyethylene has a molecular weight distribution, M_{w}/Mₙ of from about 7 to about 18.

In embodiments of the disclosure, a high density polyethylene can be made using any of the well-known catalysts capable of generating high density polyethylene, such as chromium catalysts, Ziegler-Natta catalysts and homogeneous catalysts such as but not limited to metallocene catalysts, constrained geometry catalysts, and phosphinimine catalysts.

In embodiments of the disclosure, the high density polyethylene can be made using a gas-phase, a solution-phase, or a slurry polymerization processes, or any combination thereof, using any type of reactor or reactor configuration known in the art, e.g., fluidized bed gas phase reactors, loop reactors, stirred tank reactors, batch reactors in parallel, series, and/or any combinations thereof.

In an embodiment of the disclosure, a high density polyethylene comprises from greater than 0 weight percent to 1 weight percent of a nucleating agent or a mixture of nucleating agents.

As used herein, the term “nucleating agent” refers to any material that effectively accelerates the phase transition from a molten state to a solid, semi-crystalline state in an ethylene polymer. Nucleating agent may be introduced into an ethylene polymer by kneading a mixture of the polymer, usually in powder or pellet form, with the nucleating agent, which may be utilized alone or in the form of a concentrate. Compounds known to have a nucleating capacity for polyolefins include salts of aliphatic monobasic or dibasic acids or arylalkyl acids, such as sodium succinate, or aluminum phenylacetate; and alkali metal or aluminum salts of aromatic or alicyclic carboxylic acids such as sodium β-naphthoate, or sodium benzoate. Examples of commercially available nucleating agents include dibenzylidene sorbital esters—such as the products sold under the trademark MILLAD® 3988 by Milliken Chemical and IRGACLEAR® by Ciba Specialty Chemicals—, calcium cis-1,2-cyclohexanedicarboxylate (sold under the trademark HYPERFORM® HPN-20E by Milliken Chemical), or phosphate esters, such as those sold under the trade names NA-11 and NA-21 by Asahi Denka Kogyo.

In an embodiment of the disclosure, a high density polyethylene comprises from 100 ppm (parts per million) to 3000 ppm (parts per million) of a nucleating agent or a mixture of nucleating agents.

In an embodiment, a high density polyethylene HDPE is a blend of at least two ethylene homopolymer blend components; the blend comprising: from 30 to 95 weight percent of a first ethylene homopolymer blend component having a density of from 0.950 to 0.975 g/cm³; and from 5 to 70 weight parent of a second ethylene homopolymer blend component having a density of from 0.950 to 0.975 g/cm³; wherein the ratio of the melt index I₂ of the second ethylene homopolymer blend component to the melt index 12 of the first ethylene homopolymer blend component is at least 10.

In an embodiment, a high density polyethylene HDPE essentially consists of a nucleating agent and a blend of two ethylene homopolymer blend components in which the blend consists of from 30 to 95 weight percent of a first ethylene homopolymer blend component having a density of from 0.950 to 0.975 g/cm³; and from 5 to 70 weight parent of a second ethylene homopolymer blend component having a density of from 0.950 to 0.975 g/cm³; wherein the ratio of the melt index I₂ of the second ethylene homopolymer blend component to the melt index I₂ of the first ethylene homopolymer blend component is at least 10.

In an embodiment, a high density polyethylene HDPE consists of a nucleating agent and a blend of two ethylene homopolymer blend components in which the blend consists of from 30 to 95 weight percent of a first ethylene homopolymer blend component having a density of from 0.950 to 0.975 g/cm³; and from 5 to 70 weight parent of a second ethylene homopolymer blend component having a density of from 0.950 to 0.975 g/cm³; wherein the ratio of the melt index I₂ of the second ethylene homopolymer blend component to the melt index I₂ of the first ethylene homopolymer blend component is at least 10.

### Multilayer Film Structure

The multilayer film structure of the present disclosure can be formed using a variety of techniques known in the art.

A non-limiting example of a process to prepare the multilayer film structure includes blown processes.

In the blown film extrusion process, an extruder heats, melts, mixes and conveys a thermoplastic or a blend of thermoplastics. Once molten, the thermoplastic is forced through an annular die to produce a thermoplastic tube. In the case of coextrusion, multiple extruders are employed to produce a multilayer thermoplastic tube. The temperature of the extrusion process is primarily determined by the thermoplastic or thermoplastic blend being processed, for example the melting temperature or glass transition temperature of the thermoplastic and the desired viscosity of the melt. In the case of polyolefins, typical extrusion temperatures are from 330° F. to 550° F. (166° C. to 288° C.). Upon exit from the annular die, the thermoplastic tube is inflated with air, cooled, solidified and pulled through a pair of nip rollers. Due to air inflation, the tube increases in diameter forming a bubble of desired size. Due to the pulling action of the nip rollers the bubble is stretched in the machine direction. Thus, the bubble is stretched in two directions: the transverse direction (TD) where the inflating air increases the diameter of the bubble; and the machine direction (MD) where the nip rollers stretch the bubble.

In the blown film process, air is also blown on the external bubble circumference to cool the thermoplastic as it exits the annular die. The final width of the film is determined by controlling the inflating air or the internal bubble pressure; in other words, increasing or decreasing bubble diameter. Film thickness is controlled primarily by increasing or decreasing the speed of the nip rollers to control the draw-down rate. After exiting the nip rollers, the bubble or tube is collapsed and may be slit in the machine direction thus creating sheeting. Each sheet may be wound into a roll of film. Each roll may be further slit to create film of the desired width. Each roll of film is further processed into a variety of consumer products.

Another example of a process to prepare multilayer films includes cast film processes.

The cast film process is similar in that a single or multiple extruders may be used; however, the various thermoplastic materials are metered into a flat die and extruded into a multilayer sheet, rather than a tube. In the cast film process, the extruded sheet is solidified on a chill roll.

In the cast film process, films are extruded from a flat die onto a chilled roll or a nipped roll, optionally, with a vacuum box and/or air-knife. The cast films may be coextruded multi-layer films obtained by various extrusion through a single or multiple dies. The resultant films may be used as-is or may be laminated to other films or substrates, for example by thermal, adhesive lamination or direct extrusion onto a substrate. The resultant films and laminates may be subjected to other forming operations such as embossing, stretching, thermoforming. Surface treatments such as corona may be applied, and the films may be printed.

Further examples of processes to prepare multilayer films include laminations and coatings, wherein a multilayer film structure is extrusion laminated or adhesively laminated or extrusion coated. These processes are well known to those skilled in the art.

Depending on the end-use application, the disclosed multilayer film structures span a wide range of thicknesses. Non-limiting examples include food packaging films, where thicknesses may range from about 0.5 mil to about 10 mil.

The disclosed multilayer film structures may have three, five, seven, nine, eleven or more layers.

The thickness of the sealant layer within the multilayer film structure may be about 5%, in other cases about 13.5%, in other cases about 15%, in other cases about 20%, and in still other cases about 25% of the total multilayer film thickness.

The thickness of the high density sublayer (if present) within the multilayer film structure may be about 35%, in other cases about 45%, in other cases 50%, in other cases 55%, in other cases 60, in other cases 65% and in still other cases about 70% of the total multilayer film structure thickness.

In an embodiment, a multilayer film structure comprises greater than or equal to 90%, or 93%, or 95%, or 97%, or 99%, or 100% of more than one ethylene polymer based on the total weight of the multilayer film structure excluding the non-thermoplastic layers (if present).

In an embodiment, a multilayer film structure has from 3 to 11 layers.

The multilayer film structure disclosed herein may optionally include, depending on its intended use, additives and adjuvants. Non-limiting examples of additives and adjuvants include, anti-blocking agents, antioxidants, heat stabilizers, slip agents, processing aids, anti-static additives, colorants, dyes, filler materials, light stabilizers, light absorbers, lubricants, pigments, plasticizers, nucleating agents and combinations thereof.

In an embodiment of the disclosure, the multilayer film structure has a seal initiation temperature (SIT) of less than or equal to 115° C., wherein the seal initiation temperature (SIT) is the minimum sealing temperature at which the film structure has a seal strength of greater than 3.9 N per 25.4 mm of seal width. In an embodiment of the disclosure, the multilayer film structure has a seal initiation temperature of less than or equal to 115° C. and greater than or equal to 95° C.

In an embodiment of the disclosure, the multilayer film structure has a seal strength of less than 11 N per 25.4 mm of seal width at a sealing temperature of from SIT to SIT+25° C.

In an embodiment of the disclosure, the multilayer film structure has a hot tack onset temperature of less than or equal to 110° C., wherein the hot tack onset temperature is the minimum sealing temperature at which the film structure has a hot tack force of greater than 1.0 N. In an embodiment of the disclosure, the multilayer film structure has a hot tack onset temperature of less than or equal to 110° C. and greater than or equal to 90° C.

In an embodiment of the disclosure, the multilayer film structure has a hot tack window of greater than or equal to 20° C., wherein the hot tack window is a range of sealing temperature in which the multilayer film structure has a hot tack force of greater than 2.5 N. In an embodiment of the disclosure, the multilayer film structure has a hot tack window of greater than or equal to 20° C. and less than or equal to 60° C.

### Package

The multilayer film structure disclosed herein can be used in a wide range of manufactured articles wherein at least one component of the manufactured article is formed from the multilayer film structure. A non-limiting example of such manufactured articles include packages.

In some embodiments, a package includes a peelable seal formed by heat sealing a first section of a top surface of the sealant layer of the multilayer film structure disclosed herein to a second section of the top surface of the sealant layer of the multilayer film structure disclosed herein. Depending on the package type, a variety of techniques known in the art can be applied to heat seal the first section of the top surface of the sealant layer to the second section of the top surface of the sealant layer. A non-limiting example is jaw sealing in which heat is conducted from a heat source through the multilayer film structure to the seal interface.

In some embodiments, a package is formed on form-fill-seal (FSS) packaging machines including vertical FFS (VFFS) machines. Examples of such package include pouches and stand-up pouches for food items (e.g., fresh and frozen foods, liquids, powder and granular foods).

In some embodiments the peelable seal has a peel initiation force of from 2.0 N to 15.0 N at a sealing temperature of from 110° C. to 125° C.

In some embodiments the peelable seal has a peel propagation force of from 1.0 N to 6.0 N at a sealing temperature of from 110° C. to 125° C.

In some other embodiments, a package comprises the multilayer film structure disclosed herein and a tray, and includes a peelable seal formed by heat sealing a first section of a top surface of the sealant layer of the multilayer film structure disclosed herein to the tray. Examples of such package include packages for cheese, meat, and meat products. As used herein, the term “tray” refers to a container having a substantially flat base configured for holding the product to be packaged and may further include a lateral wall extending from the base. Such tray can be formed using techniques known to those of ordinary skill in the art based on the intended use for the package. In a non-limiting example, a tray may be formed by thermoforming a monolayer or multilayer film or sheet containing at least one thermoplastic polymer. Suitable thermoplastic polymers include polyethylene terephthalate resins, polyamide resins, ethylene vinyl alcohol copolymer resins, polypropylene resins, polystyrene resins, polyethylene resins, etc. The multilayer film structure disclosed herein can be sealed to the tray using a variety of techniques and processes known in the art.

In some embodiments, a package comprising the multilayer film structure disclosed herein and a tray is formed on a thermoform-fill-seal packaging machine.

In some embodiments, a package comprising the multilayer film structure disclosed herein and a tray is formed on a preform-fill-seal machine.

In some embodiments, a package comprising the multilayer film structure disclosed herein and a tray is formed on a skin packaging machine.

### General Testing Procedures

Prior to testing, each specimen was conditioned for at least 24 hours at 23±2° C. and 50±10% relative humidity and subsequent testing was conducted at 23±2° C. and 50±10% relative humidity. Herein, the term “ASTM conditions” refers to a laboratory that is maintained at 23±2° C. and 50±10% relative humidity. ASTM refers to the American Society for Testing and Materials.

### Density

Density of the ethylene polymer in the solid state was determined using ASTM D792-13 (Nov. 1, 2013).

### Melt Index

Melt index of the ethylene polymer was determined using ASTM D1238 (Aug. 1, 2013). Melt indexes, I₂ was measured at 190° C., using a weight of 2.16 kg.

### Comonomer Content: Fourier Transform Infrared (FTIR) Spectroscopy

The quantity of the α-olefinic comonomer in the disclosed ethylene copolymer compositions were determined by FTIR and reported as the short chain branching (SCB) content having dimensions of CH₃/1000 C (number of methyl branches per 1000 carbon atoms). This test was completed according to ASTM D6645-01 (2001), employing a compression molded polymer plaque and a Thermo-Nicolet 750 Magna-IR Spectrophotometer. The polymer plaque was prepared using a compression molding device (Wabash-Genesis Series press) according to ASTM D4703-16 (April 2016).

### CRYSTAF/TREF

The “composition distribution branching index”, hereinafter CDBI, of the disclosed ethylene copolymer compositions were measured using a CRYSTAF/TREF 200+ unit equipped with an IR detector, hereinafter CTREF. The acronym “TREF” refers to Temperature Rising Elution Fractionation. The CTREF was supplied by PolymerChar S.A. (Valencia Technology Park, Gustave Eiffel, 8, Paterna, E-46980 Valencia, Spain). The CTREF was operated in the TREF mode, which generates the chemical composition of the polymer sample as a function of elution temperature and the CDBI (the composition distribution breadth index), i.e., CDBI₅₀. A polymer sample (80 to 100 mg) was placed into the reactor vessel of the CTREF. The reactor vessel was filled with 35 ml of 1,2,4-trichlorobenzene (TCB) and the polymer was dissolved by heating the solution to 150° C. for 2 hours. An aliquot (1.5 mL) of the solution was then loaded into the CTREF column which was packed with stainless steel beads. The column, loaded with sample, was allowed to stabilize at 110° C. for 45 minutes. The polymer was then crystallized from solution, within the column, by dropping the temperature to 30° C. at a cooling rate of 0.09° C./minute. The column was then equilibrated for 30 minutes at 30° C. The crystallized polymer was then eluted from the column with TCB flowing through the column at 0.75 mL/minute, while the column was slowly heated from 30° C. to 120° C. at a heating rate of 0.25° C./minute. The raw CTREF data were processed using Polymer Char software, an Excel spreadsheet and CTREF software developed in-house.

In the present disclosure, CDBI₅₀ was defined as the percent of polymer whose composition was within 50% of the median comonomer composition; CDBI₅₀ was calculated from the composition distribution curve and the normalized cumulative integral of the composition distribution curve, as described in U.S. Pat. No. 5,376,439. Those skilled in the art will understand that a calibration curve was required to convert a CTREF elution temperature to comonomer content, i.e., the amount of comonomer in the ethylene copolymer fraction that eluted at a specific temperature. The generation of such calibration curves were described in the prior art, e.g., Wild, et al., J. Polym. Sci., Part B, Polym. Phys., Vol. 20 (3), pages 441-455: hereby fully incorporated by reference. At the end of each sample run, the CTREF column was cleaned for 30 minutes; specifically, with the CTREF column temperature at 160° C., TCB flowed (0.5 mL/minute) through the column for 30 minutes.

The CTREF procedures described above are also used to determine the weight percent (wt. %) of the tested sample which elutes at a temperature range of from 90° C. to 105° C. (i.e., the integrated area of the fraction, in weight percent, of the polymer samples which elutes at from 90° C. to 105° C. in a CTREF analysis).

### Long Chain Branching Factor (LCBF)

The LCBF (dimensionless) was determined using the method described in U.S. Pat. Appl. Pub. No. 2018/0305531 which is incorporated herein by reference.

In the present disclosure, a long chain branch has a molecular weight equal to, or greater than, the entanglement molecular weight, Mₑ. Mₑ is a well-known concept in polymer physics (e.g., reported to be about 1 kg/mol for polyethylenes, see Fetters et al., Macromolecules 1999, 32, 6847). In this disclosure, long chain branches were characterized as “rheologically active”. The term “rheologically active” means the presence of long chain branches in a sample was evident after comparing rheological test results with a comparative sample that did not contain long chain branches. Non-limiting examples of rheological test results include, flow activation energy (Eₐ), shear thinning or viscosity ratios, melt flow ratios (I₂₁/I₂, I₁₀/I₂, etc.), melt strength and long chain branching factor (LCBF), etc.

LCBF calculation involved calculating a polydispersity corrected zero-shear viscosity (ZSV_{c}) and a SCB corrected intrinsic viscosity (IV_{c}). The polydispersity correction applied to the zero-shear viscosity, ZSV_{c}, had dimensions of Poise, and was performed as shown in equation eq. (1):

$${ZSV}_{c} = \frac{1.8389 \times {η}_{0}}{{2.411}^{Ln ( Pd )}} \qquad eq . ( 1 )$$

in which η₀, the zero-shear viscosity (Poise), was measured by a dynamic mechanical analysis test procedure (see the testing procedure under the heading “Dynamic Mechanical Analysis”); Pd was the dimensionless polydispersity (i.e., M_{w}/Mₙ) as measured using conventional SEC (see the testing procedure under the heading “Conventional Size Exclusion Chromatography”); 1.8389 and 2.4110 were dimensionless constants.

Calculation of the SCB-corrected intrinsic viscosity IV_{c} (having dimensions of dL/g) was performed as shown in equation eq. (2),

$${IV}_{c} = [ η ] + \frac{A \times SCB \times {M}_{v}^{0.725}}{1000000} \qquad eq . ( 2 )$$

in which the intrinsic viscosity [η] (dL/g) was measured using 3D-SEC (see the testing procedure under the heading “Triple Detection Size Exclusion Chromatography”), SCB having dimensions of (CH₃/1000 C) which was determined using FTIR (see the testing procedure under the heading “Comonomer Content: Fourier Transform Infrared Spectroscopy”), and the viscosity average molar mass Mᵥ (g/mole) was determined using 3D-SEC (see testing procure under the heading “Triple Detection Size Exclusion Chromatography”). The comonomer dependent constant A was defined above in the context of eq. (2). In the case of an ethylene homopolymer no correction is required for the Mark-Houwink constant, i.e., SCB is zero.

Non-long chain branched ethylene copolymer compositions (i.e., ethylene copolymer compositions which do not contain LCB or undetectable levels of LCB) fall on a “reference line” as defined by the following equation.

$$Log ( {IV}_{c} ) = 0.21 \times Log ( {ZSV}_{c} ) - 0.7879 \qquad eq . ( 3 )$$

The calculation of the LCBF was based on horizontal (Sₕ) and vertical (Sᵥ) shifts from the above-described linear reference line, as laid out by the following equations:

$${S}_{h} = Log ( {ZSV}_{c} ) - 4.7619 \times Log ( {IV}_{c} ) - 3.7519 \qquad eq . ( 4 )$$

$${S}_{v} = 0.21 \times Log ( {ZSV}_{c} ) - Log ( {IV}_{c} ) - 0.7879 \qquad eq . ( 5 )$$

In eq. (4) and eq. (5), it was required that the polydispersity corrected zero-shear viscosity ZSV_{c} and the SCB corrected intrinsic viscosity IV_{c} have dimensions of Poise and dL/g, respectively. The horizontal shift factor (Sₕ) was a shift in ZSV_{c} at a constant IV_{c}. If one removes the Log function its physical meaning is apparent, i.e., a ratio of two ZSV_{c}s, i.e., the ZSV_{c} of the sample under test relative to the ZSV_{c} of a non-long chain branched ethylene copolymer composition having the same IV_{c}. The horizontal shift factor (Sₕ) was dimensionless.

The vertical shift (Sᵥ) was a shift in IV_{c} at a constant ZSV_{c}. Again, if one removes the Log function its physical meaning is apparent, i.e., a ratio of two IV_{c}s of a non-long chain branched ethylene copolymer composition having the same ZSV_{c} relative to the IV_{c} of the sample under test. The vertical shift factor (Sᵥ) was dimensionless.

Finally, in the present disclosure a dimensionless long chain branching factor (LCBF) was defined by eq. (6):

$$LCBF = \frac{{S}_{h} \times {S}_{v}}{2} \qquad eq . ( 6 )$$

### Dynamic Mechanical Analysis (DMA)

Oscillatory shear measurements under small-strain amplitudes were carried out to obtain linear viscoelastic functions at 190° C. under nitrogen atmosphere, at a strain amplitude of 10% and over a frequency range of 0.02-126 rad/s at 5 points per decade. Frequency sweep experiments were performed with a TA Instruments DHR3 stress-controlled rheometer using cone-plate geometry with a cone angle of 5°, a truncation of 137 μm and a diameter of 25 mm. In this experiment a sinusoidal strain wave was applied, and the stress response was analyzed in terms of linear viscoelastic functions. The zero-shear rate viscosity (η₀) based on the DMA frequency sweep results was determined by fitting a 4-parameter Carreau-Yasuda viscosity model into the complex viscosity versus angular frequency defined by

$$\vert {η}^{*} \vert = {{η}_{0} [ 1 + {( {τ}_{c} ω )}^{a} ]}^{\frac{n - 1}{a}}$$

in which |η*| is complex viscosity measured as a function of angular frequency @, a is a parameter determining the breadth of transition from a Newtonian plateau to shear-thinning region with a slope of n−1 in a log-log plot. In the present disclosure the parameter n is set to a constant value of 2/11 and rest of model parameters were fitted by a least square method.

### Triple Detection Size Exclusion Chromatography (3D-SEC)

Polymer solutions (1 to 3 mg polymer/mL) were prepared by heating the ethylene copolymer composition sample in 1,2,4-trichlorobenzene (TCB) and rotating on a wheel for 4 hours at 150° C. in an oven. An antioxidant, 2,6-di-tert-butyl-4-methylphenol (BHT), was added to the mixture to stabilize the polymer sample against oxidative degradation. The BHT concentration was 250 ppm. Sample solutions were chromatographed at 140° C. on a PL 220 high temperature chromatography unit equipped with a differential refractive index (DRI) detector, a dual-angle light scattering detector (15 and 90 degree) and a differential viscometer. The SEC columns used were either four SHODEX® columns (HT803, HT804, HT805 and HT806), or four PL Mixed ALS or BLS columns. TCB was the mobile phase with a flow rate of 1.0 mL/minute, BHT was added to the mobile phase at a concentration of 250 ppm to protect SEC columns from oxidative degradation. The sample injection volume was 200 μL. The SEC raw data were processed with the CIRRUS® GPC software, to produce absolute molar masses and intrinsic viscosity ([η]) and viscosity average molar mass (Mᵥ). The term “absolute” molar mass was used to distinguish 3D-SEC determined absolute molar masses from the molar masses determined by conventional SEC. The viscosity average molar mass (Mᵥ) and intrinsic viscosity ([η]) determined by 3D-SEC were used in calculations to determine the long chain branching factor (LCBF).

### Conventional Size Exclusion Chromatography (SEC)

Polymer solutions (1 to 3 mg/mL) were prepared by heating the polymer in 1,2,4-trichlorobenzene (TCB) and rotating on a wheel for 4 hours at 150° C. in an oven. An antioxidant, 2,6-di-tert-butyl-4-methylphenol (BHT), was added to the mixture in order to stabilize the polymer against oxidative degradation. The BHT concentration was 250 ppm. Polymer solutions were chromatographed at 140° C. on a PL 220 high-temperature chromatography unit equipped with four SHODEX columns (HT803, HT804, HT805 and HT806) using TCB as the mobile phase with a flow rate of 1.0 mL/minute, with a differential refractive index (DRI) as the concentration detector. BHT was added to the mobile phase at a concentration of 250 ppm to protect GPC columns from oxidative degradation. The sample injection volume was 200 μL. The GPC columns were calibrated with narrow distribution polystyrene standards. The polystyrene molecular weights were converted to polyethylene molecular weights using the Mark-Houwink equation, as described in the ASTM standard test method D6474-12 (December 2012). The GPC raw data were processed with the CIRRUS GPC software, to produce molar mass averages (Mₙ, M_{w}, M_{z}) and molar mass distribution (e.g., Polydispersity, M_{w}/Mₙ). In the polyethylene art, a commonly used term that is equivalent to SEC is GPC, i.e., Gel Permeation Chromatography.

### GPC-FTIR

Polymer solutions were prepared by heating 2 to 4 mg/mL of the ethylene copolymer composition sample in 1,2,4-trichlorobenzene (TCB) and rotating on a wheel for 4 hours at 150° C. in an oven. The antioxidant 2,6-di-tert-butyl-4-methylphenol (BHT) was added to the mixture in order to stabilize the polymer against oxidative degradation. The BHT concentration was 250 ppm. Sample solutions were chromatographed at 140° C. on a Waters GPC 150C chromatography unit equipped with four SHODEX columns (HT803, HT804, HT805 and HT806) using TCB as the mobile phase with a flow rate of 1.0 mL/minute, with a FTIR spectrometer and a heated FTIR flow through cell coupled with the chromatography unit through a heated transfer line as the detection system. BHT was added to the mobile phase at a concentration of 250 ppm to protect SEC columns from oxidative degradation. The sample injection volume was 300 μL. The raw FTIR spectra were processed with OPUS FTIR software, and the polymer concentration and methyl content were calculated in real time with the Chemometric Software (PLS technique) associated with the OPUS. Then the polymer concentration and methyl content were acquired and baseline-corrected with the CIRRUS GPC software. The SEC columns were calibrated with narrow distribution polystyrene standards. The polystyrene molecular weights were converted to polyethylene molecular weights using the Mark-Houwink equation, as described in the ASTM standard test method D6474. The comonomer content was calculated based on the polymer concentration and methyl content predicted by the PLS technique as described in Paul J. DesLauriers, Polymer 43, pages 159-170 (2002); herein incorporated by reference.

The GPC-FTIR method measures total methyl content, which includes the methyl groups located at the ends of each macromolecular chain, i.e. methyl end groups. Thus, the raw GPC-FTIR data must be corrected by subtracting the contribution from methyl end groups. To be clear, the raw GPC-FTIR data overestimates the amount of short chain branching (SCB) and this overestimation increases as molecular weight decreases. In this disclosure, raw GPC-FTIR data was corrected using the 2-methyl correction. At a given molecular weight (M), the number of methyl end groups (N_{E}) was calculated using the following equation; N_{E}=28000/M, and N_{E} (M dependent) was subtracted from the raw GPC-FTIR data to produce the SCB per 1000 carbon atoms (2-Methyl corrected) GPC-FTIR data.

### Hot Tack

In the present disclosure, the “Hot Tack Test” was performed as follows. Hot tack data was generated using a J&B Hot Tack Tester which is commercially available from Jbi Hot Tack, Geloeslaan 30, B-3630 Maamechelen, Belgium. In the hot tack test, the strength of a seal is measured immediately after heat sealing two film samples together, i.e., when the macromolecules that include the film are in a semi-molten state—the two film samples were cut from the same roll of film. This test simulates the heat sealing of films on high speed automatic packaging machines, e.g., vertical or horizontal form, fill and seal (VFFS) equipment. The following parameters were used in the J&B Hot Tack Test: film specimen width, 1 inch (25.4 mm); film sealing time, 0.5 second; film sealing pressure, 0.27 N/mm²; delay time, 0.5 second; film peel speed, 7.9 in/second (200 mm/second); testing temperature range, 131° F. to 293° F. (55° C. to 145° C.); temperature increments, 9° F. (5° C.); and five film samples were tested at each temperature increment to calculate average values at each temperature. In this way, a hot tack profile of pulling force vs sealing temperature is generated. The following data can be calculated from this hot tack profile: the “Hot Tack Onset Temperature @ 1.0 N (in ° C.)” or the “HTOT”, is the temperature at which a hot tack force of IN was observed (an average of five film samples); the “Max Hot tack Strength (N)”, is the maximum hot tack force observed (an average of five film samples) over the testing temperature range; the “Temperature—Max. Hot tack (in ° C.)”, is the temperature at which the maximum hot tack force was observed. Finally, the hot-tack (strength) window (the “hot tack window” or the “HTW”) is defined as the range of temperature, in ° C., spanned by the hot tack curve at a given seal strength, for example 2.5 Newtons. A person skilled in the art will realize that a hot tack window can be determined for differently defined seal strengths. Generally speaking, for a given seal strength, the larger the hot tack window, the greater the temperature window over which a high sealing force can be maintained or achieved.

### Seal Strength

In the present disclosure, the “Heat Seal Strength Test” (also known as “the cold seal test”) was performed as follows. Heat seal data was generated using a conventional Instron Tensile Tester. In this test, two film samples are sealed over a range of temperatures—the two film samples were cut from the same roll of film. The following parameters were used in the Heat Seal Strength (or cold seal) Test: film specimen width, 1 inch (25.4 mm); film sealing time, 0.5 second; film sealing pressure, 40 psi (0.28 N/mm²); temperature range, 212° F. to 302° F. (100° C. to 150° C.) and temperature increment, 9° F. (5° C.). After aging for at least 24 hours at ASTM conditions, seal strength was determined using the following tensile parameters: pull (crosshead) speed, 12 inch/min (2.54 cm/min); direction of pull, 90° to seal; and 5 samples of film were tested at each temperature increment. The Seal Initiation Temperature, hereafter “SIT”, is defined as the temperature at which a seal strength of greater than 3.9 N per 25.4 mm of seal width is achieved.

### Peel Initiation and Propagation Testing

In the present disclosure, a peel initiation and propagation test procedure was applied to simulate the force profile experienced by a user during the opening process of a sealed package prepared from the multilayer film structures disclosed herein as a function of the opening distance. The test procedure measured the force required to initiate the separation of the seal and the force required for the continuous peeling of the seal resulting in complete separation of the sealed area. In the present disclosure, a pouch with a fin seal produced on a vertical form-fill-seal (VFFS) machine was tested “as-is” after aging at least 24 hours at ASTM conditions using an INSTRON® 5965 universal tester following the procedure described in ASTM D882-02. Using a top rubber faced grip clamped onto the longitudinal fin and a bottom rubber faced grip clamped onto the inner wall of the pouch immediately below the longitudinal fin seal at an initial grip separation of 0.5 inches, the seal was pulled at a rate of grip separation of 20 inches/min. The peel initiation force was reported according to the maximum tensile force observed within a travel distance of less than 1.0 inch, and the peel propagation force was reported according to the average force observed along a travel distance of from 1.0 inch to 4.0 inches.

### EXAMPLES

The following examples are presented for the purpose of illustrating selected embodiments of this disclosure—it being understood that the examples presented do not limit the claims presented.

### Multilayer Film Structures

The following ethylene polymers were used in the EXAMPLES section to prepare multilayer film structures.

TABLE 1
Ethylene Polymer Used to Prepare Multilayer Film Structures.

| | | | TREF | TREF | | | |
|---|---|---|---|---|---|---|---|
| | | | frac. 1 | frac. 2 | | | |
| | Density | I₂ | [30 90° C.] | [90 105° C.] | CDBI₅₀ | LCBF | M_{w}/Mₙ |
| | (g/cm³) | (dg/min) | (wt. %) | (wt. %) | (%) | (—) | (—) |
| ZN C₂/C₄ copolymer 1 | 0.925 | 4.8 | 84.5 | 15.5 | 57.4 | <0.001 | 3.6 |
| SSC C₂/C₈ copolymer 1 | 0.917 | 4.5 | 95.2 | 4.8 | 81.8 | <0.001 | 2.1 |
| ZN C₂/C₈ copolymer 1 | 0.920 | 1.0 | 84.0 | 16.0 | 55.5 | <0.001 | 3.4 |
| Met. C₂/C₈ copolymer 2 | 0.905 | 1.0 | 99.9 | 0.1 | 90.3 | 0.038 | 3.2 |
| Met./ZN C₂/C₈ copolymer 2 | 0.908 | 0.9 | 88.9 | 11.1 | 60.2 | 0.007 | 2.9 |
| SSC HDPE (nuc.) | 0.967 | 1.0 | — | — | — | — | — |
| ZN HDPE | 0.962 | 0.7 | — | — | — | — | — |

In Table 1, the term “ZN” indicates that the ethylene copolymer composition or the high density polyethylene (HDPE) resin was prepared with a Ziegler-Natta catalyst system. The term “SSC” indicate that the ethylene copolymer composition or the high density polyethylene (HDPE) resin was prepared with a homogenous catalyst system. The term “Met.” indicates that the ethylene copolymer composition was prepared with a metallocene catalyst system. The term “nuc.” indicates that the respective resin contained a target concentration of 1200 part per million (ppm) by weight of a nucleating agent commercially available from Milliken Chemicals under the tradename HYPERFORM® HPN®-20E.

ZN C₂/C₄ copolymer 1 was an ethylene/butene-1 copolymer composition prepared in a commercial-scale solution polymerization process using a Ziegler-Natta catalyst system. ZN C₂/C₄ copolymer 1 contained about 94.0 weight percent of ethylene with the balance of the copolymer being butene-1, as determined by Fourier Transform Infrared (FTIR) Spectroscopy. ZN C₂/C₄ copolymer 1 had a conventional SEC polydispersity M_{w}/Mₙ of 3.6 and contained an undetectable levels of long chain branching as characterized according to a LCBF of less than 0.001. ZN C₂/C₄ copolymer 1 had a nominal density of 0.925 g/cm³ and a nominal melt index I₂ of 4.8 dg/min.

SSC C₂/C₈ copolymer 1 was an ethylene/octene-1 copolymer composition prepared in a commercial-scale solution polymerization process using a phosphinimine homogeneous catalyst system. SSC C₂/C₈ copolymer 1 contained about 89.5 weight percent of ethylene with the balance of the copolymer being octene-1. SSC C₂/C₈ copolymer 1 had a polydispersity M_{w}/Mₙ of 2.1 and contained an undetectable levels of long chain branching as characterized according to a LCBF of less than 0.001. SSC C₂/C₈ copolymer 1 had a nominal density of 0.917 g/cm³ and a nominal melt index I₂ of 4.5 dg/min.

ZN C₂/C₈ copolymer 1 was an ethylene/octene-1 copolymer composition prepared in a commercial-scale solution polymerization process using a Ziegler-Natta catalyst system. ZN C₂/C₈ copolymer 1 contained about 90.7 weight percent of ethylene with the balance of the copolymer being octene-1. ZN C₂/C₈ copolymer 1 had a polydispersity M_{w}/Mₙ of 3.4 and contained an undetectable levels of long chain branching as characterized according to a LCBF of less than 0.001. ZN C₂/C₈ copolymer 1 had a nominal density of 0.920 g/cm³ and a nominal melt index I₂ of 1.0 dg/min.

Met. C₂/C₈ copolymer 2 was an ethylene/octene-1 copolymer composition prepared in a commercial-scale solution polymerization process using a metallocene-type catalyst system. Met. C₂/C₈ copolymer 2 contained about 83.0 weight percent of ethylene with the balance of the copolymer being octene-1. Met. C₂/C₈ copolymer 2 had a polydispersity M_{w}/Mₙ of 3.2 and contained an detectable levels of long chain branching as characterized according to a LCBF of greater than or equal to 0.001. Met. C₂/C₈ copolymer 2 had a nominal density of 0.905 g/cm³ and a nominal melt index I₂ of 1.0 dg/min.

Met./ZN C₂/C₈ copolymer 2 was an ethylene/octene-1 copolymer composition prepared in a commercial-scale solution polymerization process using a metallocene-type catalyst system and a Ziegler-Natta catalyst system. Met./ZN C₂/C₈ copolymer 2 contained about 85.0 weight percent of ethylene with the balance of the copolymer being octene-1. Met./ZN C₂/C₈ copolymer 2 had a polydispersity M_{w}/Mₙ of 2.9 and contained an detectable levels of long chain branching as characterized according to a LCBF of greater than or equal to 0.001. Met./ZN C₂/C₈ copolymer 2 had a nominal density of 0.908 g/cm³ and a nominal melt index I₂ of 0.9 dg/min.

SSC HDPE (nuc.) was a high density polyethylene (HDPE) resin prepared in a commercial-scale solution polymerization process by homopolymerization of ethylene using a phosphinimine homogeneous catalyst system. SSC HDPE contained a target concentration of 1200 part per million (ppm) by weight of a nucleating agent commercially available from Milliken Chemicals under the tradename HYPERFORM HPN-20E. SSC HDPE had a nominal density of 0.967 g/cm³ and a nominal melt index I₂ of 1.0 dg/min.

ZN HDPE was a high density polyethylene (HDPE) resin prepared in a commercial-scale solution polymerization process by homopolymerization of ethylene using a Ziegler-Natta catalyst system. ZN HDPE had a nominal density of 0.962 g/cm³ and a nominal melt index I₂ of 0.72 dg/min.

Three layer coextruded blown films were fabricated using a Brampton 3-layer blown film line. This line was equipped with three extruders such that A/B/C coextruded film structures in which A, B and C represent distinct thermoplastic layers can be produced. Layer A was a sealant layer. Layer B was a sublayer sandwiched between the sealant layer A and a skin layer C. All three extruders had a consistent barrel diameter (D) of 1.75 inch (4.45 cm) and barrel length (L) with an extruder barrel length to diameter ratio of 30 (L/D). The 3-layer blown film die was a pancake design and the exit lip diameter was 4 inch (10.2 cm). A Saturn I air ring was used to quench the extrudate. The following operating conditions were used to generate three layer blown film samples: Blow-up-ratio (BUR) of 3.0:1; 4 inch (10.2 cm) die; 35 mil (0.089 cm) die gap; and frost line height was 13 inch (33 cm). The temperature set points and the actual melt temperatures at the die exit on the 3-layer blown film line are shown in Table 2.

Structure 1 was an A/B/C three-layer structure in which the sealant layer (A) was prepared from a 48%/32%/18%/2% (by weight) blend of the ZN C2/C4 copolymer 1, the Met. C2/C8 copolymer 2, TOPPYL® PB 8640M and a process-aid masterbatch. TOPPYL PB 8640M is a random copolymer of butene-1 with low ethylene content commercially available from LyondellBasell Industries. TOPPYL PB 8640M has a nominal melt index I₂ of 1.0 dg/min and a nominal density of 0.906 g/cm³. The process-aid masterbatch was a masterbatch of a fluoroelastomer type process-aid commercially available from Ingenia Polymers under the commercial name Ingenia 1150. Ingenia 1150 masterbatch contains 5% (by weight) of 3M DYNAMAR® FX 5920A in an LLDPE carrier resin having a melt index I₂ of 1.0 and a density of 0.920 g/cm³. The sublayer B in Structure 1 was prepared from a 78%/22% (by weight) blend of the SSC HDPE and the ZN HDPE. The skin layer C in Structure 1 was prepared from a 97%/3% (by weight) blend of ZN HDPE and the process-aid masterbatch.

Structure 1A had an identical layers' composition as the three-layer film prepared in Structure 1, except that, in Structure 1A, the sublayer B in Structure 1A was prepared from 100% of the SSC HDPE.

Structure 2 had identical layers' composition as the three-layer film prepared in Structure 1, except that, in Structure 2, the sealant layer A was prepared from a 28%/52%/18%/2% (by weight) blend of the ZN C2/C4 copolymer 1, the Met. C2/C8 copolymer 2, TOPPYL PB 8640M and the process-aid masterbatch.

Structure 3 had identical layers' composition as the three-layer film prepared in Structure 1, except that, in Structure 3, the sealant layer A was prepared from a 48%/32%/18%/2% (by weight) blend of the SSC C2/C8 copolymer 1, the Met. C2/C8 copolymer 2, TOPPYL PB 8640M and the process-aid masterbatch.

Comparative Structure 1 had identical layers' composition as the three-layer film prepared in Structure 1, except that, in Comparative Structure 1, the sealant layer A was prepared from a 78%/20%/2% (by weight) blend of ULTRATHENE® UE624000, TOPPYL PB 8640M and the process-aid masterbatch. ULTRATHENE UE624000 is an ethylene vinyl acetate (EVA) copolymer commercially available from LyondellBasell Industries which contains 18% by weight of vinyl acetate comonomer, and has a nominal melt index I₂ of 2.1 dg/min.

Comparative Structure 2 had identical layers' composition as the three-layer film prepared in Structure 1, except that, in Comparative Structure 2, the sealant layer A was prepared from a 20%/60%/18%/2% (by weight) blend of ZN C₂/C₈ copolymer 1, the Met./ZN C₂/C₈ copolymer 2, TOPPYL PB 8640M and the process-aid masterbatch.

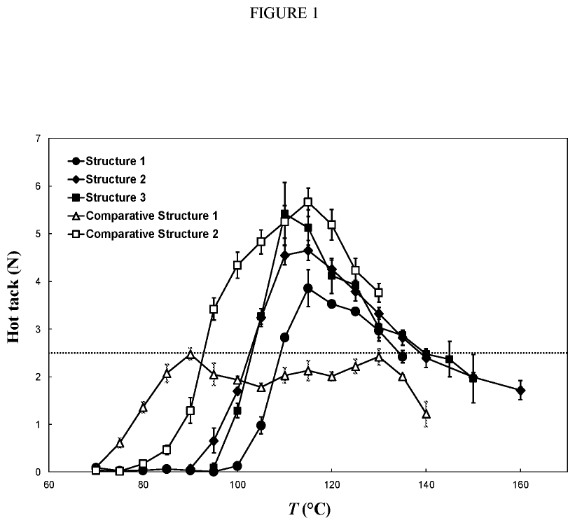

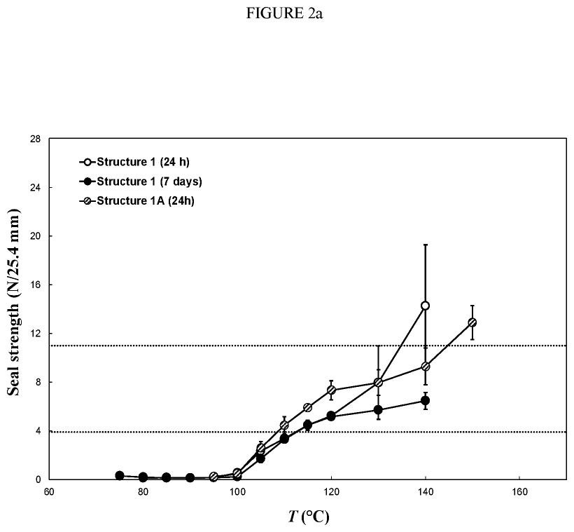

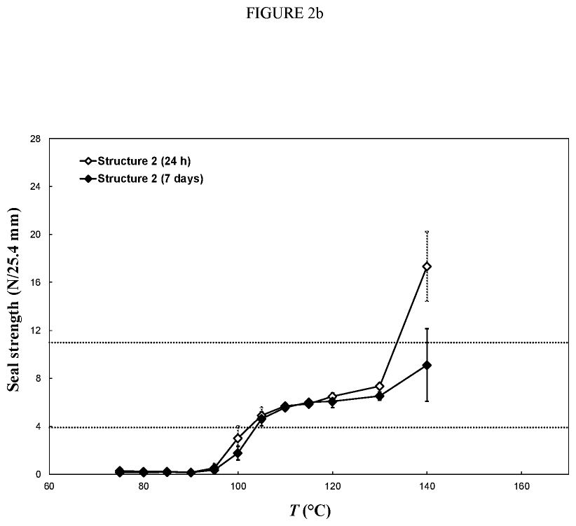

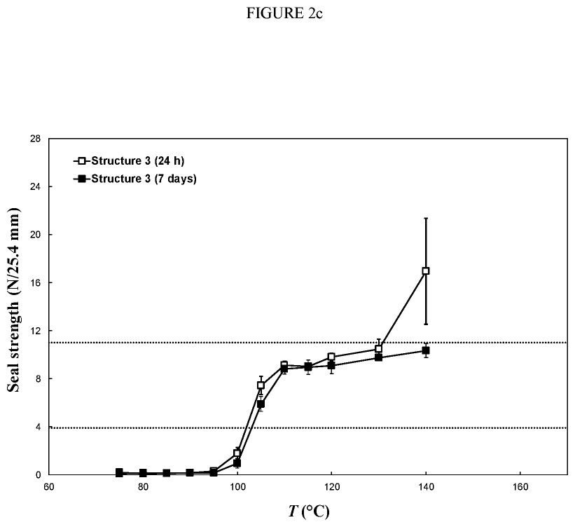

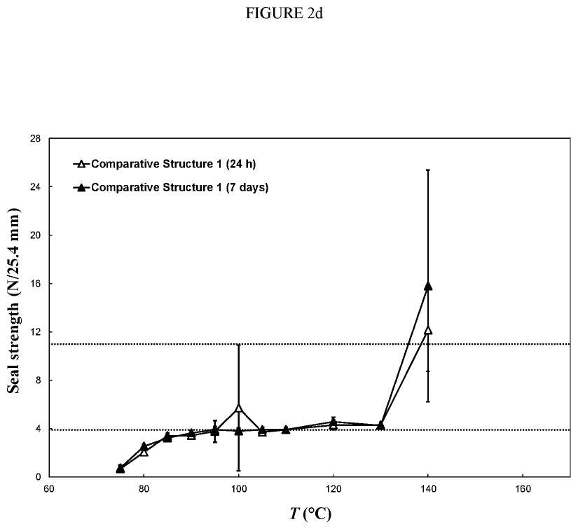

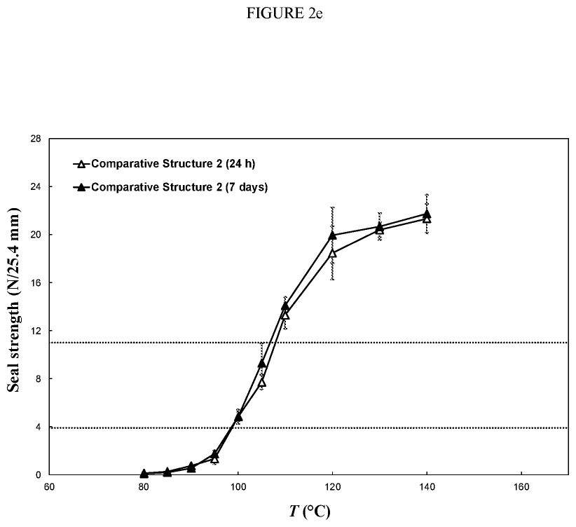

FIG. 1 and FIGS. 2a-2e illustrate the hot tack and seal strength profiles of film structures prepared in Structures 1, 1A and 2-3, and Comparative Structures 1-2. As recognized by those skilled in the art PB-1 requires seven to ten days for complete crystallization before it obtains its ultimate properties. In FIGS. 2a-2e, the seal strength data obtained for structures conditioned for 24 hours under the ASTM conditions were coplotted with the seal strength profiles obtained for structures which were conditioned for seven days.

Table 3 summarizes the sealing properties—i.e., hot tack onset temperature (HTOT) at 1.0 N, maximum hot tack strength, hot tack window at 2.5 N and seal initiation temperature at 3.9 N/2.5 mm—for the film structures prepared in Structures 1-3 and Comparative Structures 1-2. In Table 3, the temperatures corresponding to HTOT at 1.0 N, hot tack window at 2.5 N and/or seal initiation temperature at 3.9 N/2.5 mm were estimated using a linear interpolation routine in cases where a force of 1.0 N, 2.5 N and/or 3.9 N were not directly measurable in the experimentally-obtained hot tack and/or seal strength profiles.

The data provided in Table 3 together with FIG. 1 demonstrated that the multilayer films prepared in Structures 1-3 relative to the Comparative Structure 1 exhibited improved hot tack window at 2.5 N and maximum hot tack strength. With reference to FIGS. 2a-2e, it was further observable that Structures 1-3 showed a decreased variability in seal strength at a sealing temperature of 140° C. when compared to the Comparative Structure 1. Noticeably, and contrary to the Comparative Structure 1, Structures 1-3, which were conditioned for 7 days, had seal strength values well within the 3.9 N to 11 N interval over the entire sealing temperature range of from SIT at 3.9 N to 140° C.

Further and more importantly, the Comparative Structure 2 which in its sealant layer contained a first ethylene copolymer having a melt index (I₂) of 1.0 dg/min (ZN C₂/C₈ copolymer 1) exhibited no intermediate plateau in seal strength which, relative to the multilayer film structures prepared in Structures 1-3, resulted in a narrow sealing temperature window spanning the seal strength curve at a seal strength range of from 3.9 to 11.0 N/25.4 mm.

TABLE 2a
Blown Film Coextrusion Process Conditions.

| | Structure 1 | Structure 1A | Structure 2 |
|---|---|---|---|
| Structure Thickness (mil) | 1.6 | 2.8 | 1.6 |
| Coextruded Structure | A/B/C | A/B/C | A/B/C |
| Sealant Layer (A) | 48% ZN C₂/C₄ | 48% ZN C₂/C₄ | 28% ZN C₂/C₄ |
| | copolymer 1/ | copolymer 1/ | copolymer 1/ |
| | 32% Met. C₂/C₈ | 32% Met. C₂/C₈ | 52% Met. C₂/C₈ |
| | copolymer 2/ | copolymer 2/ | copolymer 2/ |
| | 18% PB-1/ | 18% PB-1/ | 18% PB-1/ |
| | 2% PPA MB | 2% PPA MB | 2% PPA MB |
| Sealant Layer Thickness % | 13.5 | 20 | 13.5 |
| Sublayer (B) | 78% SSC HDPE/ | 100% SSC | 78% SSC HDPE/ |
| | 22% ZN HDPE | HDPE | 22% ZN HDPE |
| Sublayer % | 65.0 | 40 | 65.0 |
| Skin Layer (C) | 97% ZN HDPE/ | 97% ZN HDPE/ | 97% ZN HDPE/ |
| | 3% PPA MB | 2% PPA MB | 3% PPA MB |
| Skin Layer % | 21.5 | 20 | 21.5 |
| Feed Throat Temperature | 75/75/75 | 75/75/75 | 75/75/75 |
| (setpoint)* (° F.) | | | |
| Barrel Zone 1 - setpoint* (° F.) | 370/370/370 | 370/370/370 | 370/370/370 |
| Barrel Zone 2 - setpoint* (° F.) | 390/390/390 | 390/390/390 | 390/390/390 |
| Barrel Zone 3 - setpoint* (° F.) | 400/400/400 | 400/400/400 | 400/400/400 |
| Barrel Zone 4 - setpoint* (° F.) | 400/400/400 | 400/400/400 | 400/400/400 |
| Screen - setpoint* (° F.) | 400/400/400 | 400/400/400 | 400/400/400 |
| Adaptor - setpoint* (° F.) | 400/400/400 | 400/400/400 | 400/400/400 |
| Die Module - setpoint* (° F.) | 400/400/400 | 400/400/400 | 400/400/400 |
| Melt Temperature - actual* (° F.) | 401/422/412 | 411/416/431 | 401/424/411 |
| Output Rate* (lb/h) | 10.4/52.8/17.3 | 19.2/40.5/40.2 | 10.3/52.8/17.3 |
| Extruder RPM* | 15.4//62.3/31.0 | 29.4/43.2/70.6 | 15.5/61.7/31.1 |
| Barrel Pressure* (psig) | 2006/3328/3025 | 2542/2718/4029 | 2247/3382/3169 |
| Air Ring Temperature (° F.) | 30 | 31 | 30 |
| Air Ring Pressure (inch of H₂O) | 3 | 3.5 | 3 |
| Nip Pressure (psi) | 35 | 30 | 35 |
| Line Speed (feet per minute) | 51.9 | 45.0 | 51.9 |
| Layflat (inch) | 18.97 | 15.70 | 18.78 |

*values are listed in order of extruder A/extruder B/extruder C.

TABLE 2b
Blown Film Coextrusion Process Conditions.

| | | Comparative | Comparative |
|---|---|---|---|
| | Structure 3 | Structure 1 | Structure 2 |
| Structure Thickness (mil) | 1.6 | 1.6 | 1.6 |
| Coextruded Structure | A/B/C | A/B/C | A/B/C |
| Sealant Layer (A) | 48% SSC C₂/C₈ | 78% EVA/ | 20% ZN C₂/C₈ |
| | copolymer 1/ | 20% PB-1/ | copolymer 1/ |
| | 32% Met. C₂/C₈ | 2% PPA MB | 60% Met./ZN C₂/C₈ |
| | copolymer 2/ | | copolymer 2/ |
| | 18% PB-1/ | | 18% PB-1/ |
| | 2% PPA MB | | 2% PPA MB |
| Sealant Layer Thickness % | 13.5 | 13.5 | 13.5 |
| Sublayer (B) | 72% SSC HDPE/ | 72% SSC HDPE/ | 72% SSC HDPE/ |
| | 28% ZN HDPE | 28% ZN HDPE | 28% ZN HDPE |
| Sublayer % | 65.0 | 51.5 | 65.0 |
| Skin Layer (C) | 98% ZN HDPE/ | 98% ZN HDPE/ | 98% ZN HDPE/ |
| | 2% PPA MB | 2% PPA MB | 2% PPA MB |
| Skin Layer % | 21.5 | 35.0 | 21.5 |
| Feed Throat Temperature - | 75/75/75 | 60/60/60 | 60/60/60 |
| Setpoint* (° F.) | | | |
| Barrel Zone 1 - setpoint* (° F.) | 370/370/370 | 370/370/370 | 370/370/370 |
| Barrel Zone 2 - setpoint* (° F.) | 390/390/390 | 390/390/390 | 390/390/390 |
| Barrel Zone 3 - setpoint* (° F.) | 400/400/400 | 400/400/400 | 400/400/400 |
| Barrel Zone 4 - setpoint* (° F.) | 400/400/400 | 400/400/400 | 400/400/400 |
| Screen - setpoint* (° F.) | 400/400/400 | 400/400/400 | 400/400/400 |
| Adaptor - setpoint* (° F.) | 400/400/400 | 400/400/400 | 400/400/400 |
| Die module - setpoint* (° F.) | 400/400/400 | 400/400/400 | 400/400/400 |
| Melt Temperature - actual* (° F.) | 402/422/412 | 398/417/420 | 406/423/412 |
| Output Rate* (lb/h) | 10.4/52.8/17.3 | 10.5/41.7/28.1 | 10.3/52.5/17.2 |
| Extruder RPM* | 16.4/62.0/30.9 | 14.9/49.4/48.6 | 20.6/66.6/30.9 |
| Barrel Pressure* (psig) | 2003/3090/3169 | 1827/3609/3307 | 2865/3565/2932 |
| Air Ring Temperature (° F.) | 30 | 20 | 20 |
| Air Ring Pressure (inch of H₂O) | 3.5 | 5 | 5 |
| Nip Pressure (psi) | 35 | 30 | 30 |
| Line Speed (feet per minute) | 52.0 | 52.4 | 52.2 |
| Layflat (inch) | 18.88 | 19.63 | 19.70 |

*values are listed in order of extruder A/extruder B/extruder C.

Without wishing to be bound by theory, the superior hot tack window and maximum hot tack strength afforded by the Structures 1-3 are desired in high speed vertical and horizontal form-fill-seal processes where a product (liquid, solid, paste, part, etc.) is loaded and sealed inside a pouch-like package. Generally, in such packaging applications, film structures that have broad hot tack windows are desired, as such structures may consistently produce leak-proof packages as various parameters are changed on the packaging equipment. Further, it is desirable that a high hot tack seal strength at high temperatures, such that the seal strength remains sufficient at a range of elevated temperatures (e.g., compare hot tack force profiles of Structures 1-3 in FIG. 1 at T>110° C. with that of the Comparative Structure 1).

TABLE 3
Sealing Properties of the Multilayer Film Structures Prepared
in Structures 1-3 and Comparative Structure 1.

| | HTOT at | Maximum Hot | Hot Tack | SIT* at |
|---|---|---|---|---|
| | 1.0N | Tack Strength | Window at 2.5N | 3.9N |
| | (° C.) | (N) | (° C.) | (° C.) |
| Structure 1 | 105.0 | 3.9 | 26.0 | 112.6 |
| Structure 2 | 96.6 | 4.7 | 36.1 | 103.7 |
| Structure 3 | 98.8 | 5.4 | 36.7 | 103.0 |
| Comparative | 77.6 | 2.5 | —^{†} | 94.7 |
| Structure 1 | | | | |
| Comparative | 88.2 | 5.7 | —^{‡} | 98.5 |
| Structure 2 | | | | |

*listed SIT values are for structures conditioned under the ASTM conditions for seven days.
^{†}No hot tack window was reported as Comparative Structure 1 did not achieve a hot tack force of greater than 2.5N.
^{‡}No hot tack window was reported as no hot tack force below 2.5N was observable at the upper end of the test window.

### Peel Initiation/Propagation Test Results

A ROVEMA vertical form-fill-Seal (VFFS) machine was used for producing pouches from the multilayer films described in Structures 1-3 and the Comparative Structure 1. Multilayer films were slitted into 14.75-in wide web for producing empty fin sealed pouches having dimensions of 175 mm (width) by 200 mm (length) at a bag rate of 20 bags per minutes with 100% sealing pressure and a dwell time of 500 milliseconds. No test data were shown in Table 4 for sealing temperatures where a leak proof seal was not achievable (at low sealing temperatures) or where the seal was a lockup seal and thus was not openable by hand (at high sealing temperature).

As appreciated by those of ordinary skill in art, the conventional seal strength-sealing temperature curves provides no details as to the force profile experienced by a user during the opening process as a function of the opening distance and thus would be inconclusive in differentiating film structures in terms of their easy-opening performance. Table 4 illustrates peel initiation force and peel propagation force data as determined by the method described in the General Testing Procedures under the section “Peel Initiation and Propagation Testing” for the pouches prepared from Structures 1 through 3 and Comparative Structures 1 and 2.

At a given temperature above the seal initiation temperature, the pouch prepared from Structures 1 and 2 demonstrated peel initiation/propagation force values comparable to or improved (decreased) over the Comparative Structure 1. To be clear, for example, at SIT+5-7° C.~120° C. (see SIT values disclosed in Table 3), the pouch prepared from Structure 1 had a seal initiation force of 4.5 N and a seal propagation force of 1.5 N. At SIT+5-7° C.~110° C., the pouch prepared from Structure 2 had a peel initiation force of 4.1 N and a peal propagation force of 1.4 N. The pouch prepared from Comparative Structure 1, at SIT+5-7° C.~100° C., had a peel initiation force of 4.3 N and a peal propagation force of 1.4 N. Comparative Structure 2 at SIT+5-7° C.~105° C. had a peel initiation force of 8.4 N and a peal propagation force of 4.5 N.

TABLE 4
Peel Initiation and Propagation Force Data for Pouches Prepared from Structures
1-3 and Comparative Structures 1-2. Values Shown in Parentheses are Standard
Deviation Values Corresponding to Ten Independent Measurements.

| | | Sealing Temperature (° C.) | | | | | | |
|---|---|---|---|---|---|---|---|---|
| | | 95 | 100 | 105 | 110 | 115 | 120 | 125 |
| Structure 1 | Peel Initiation | — | — | — | 2.0 | 3.3 | 4.5 | 7.7 |
| | Force (N) | | | | (0.2) | (0.7) | (0.3) | (1.7) |
| | Peel Propagation | — | — | — | 1.0 | 1.3 | 1.5 | 1.7 |
| | Force (N) | | | | (0.2) | (0.2) | (0.2) | (0.4) |
| Structure 2 | Peel Initiation | — | — | 2.6 | 4.1 | 5.7 | 8.1 | — |
| | Force (N) | | | (0.5) | (0.5) | (0.6) | (0.8) | |
| | Peel Propagation | — | — | 1.1 | 1.4 | 1.7 | 1.6 | — |
| | Force (N) | | | (0.2) | (0.2) | (0.3) | (0.2) | |
| Structure 3 | Peel Initiation | — | — | 3.7 | 10.1 | 11.4 | 14.2 | — |
| | Force (N) | | | (0.5) | (0.8) | (1.2) | (1.4) | |
| | Peel Propagation | — | — | 1.9 | 4.8 | 5.1 | 5.5 | — |
| | Force (N) | | | (0.4) | (0.6) | (1.3) | (1.5) | |
| Comparative | Peel Initiation | 3.4 | 4.3 | 5.6 | 6.3 | 8.4 | — | — |
| Structure 1 | Force (N) | (0.5) | (0.5) | (0.4) | (1.1) | (1.3) | | |
| | Peel Propagation | 1.1 | 1.4 | 1.3 | 1.6 | 1.9 | — | — |
| | Force (N) | (0.1) | (0.2) | (0.3) | (0.3) | (0.5) | | |
| Comparative | Peel Initiation | 1 | 4.8 | 8.4 | 16.7* | | | |
| Structure 2 | Force (N) | (—) | (—) | (—) | (—) | | | |
| | Peel Propagation | 0.3 | 1.2 | 4.5 | 11 | | | |
| | Force (N) | (—) | (—) | (—) | (—) | | | |

*Lockup seal

### Nine-Layer Film Structures

Nine-layer Structures 4 through 7, and Comparative Structures 3 and 4 were produced on a nine-layer line film blowing line commercially available from Brampton Engineering (Brampton ON, Canada). The structure and the temperature settings of the nine-layer Structures 4-7, and the Comparative Structure 3 and 4 are shown in Table 4. The total thickness of the Comparative Examples 3 was 1.6 mil; the Comparative Examples 4 was 2 mil; the total thickness of the Structures 4 and 5 were 1.6 mil; and the total thickness of the Structures 6 and 7 were 2 mil. The die technology consisted of a pancake die, FLEX-STACK Co-extrusion die (SCD), with flow paths machined onto both sides of a plate, the die tooling diameter was 6.3-inches, in this disclosure a die gap of 85-mil was used consistently, film was produced at a blow-up ratio (BUR) of 2.2 and the output rate of the line was held constant at 225 lb/hr. The specifications of the nine extruders follow: screws 1.5-in diameter, 30/1 length to diameter ratio, 8-polyethylene screws with single flights and Maddox mixers, 1-Nylon screw, extruders were air cooled, equipped with 20-H.P. motors and all extruders were equipped with gravimetric blenders. The nip and collapsing frame included a Decatex horizontal oscillating haul-off and pearl cooling slats just below the nips. The line was equipped with a turret winder and oscillating slitter knives. Table 5 summarizes the temperature settings used. All die temperatures were maintained at a constant 430° F., i.e., layer sections, mandrel bottom, mandrel, inner lip and outer lip.

TABLE 5
Temperature Settings Applied to Film Blowing Process used in Preparation of
the Nine-Layer Structures 4 through 7, and Comparative Structures 3 and 4.

| | Feed | Barrel | Barrel | Barrel | Barrel | | |
|---|---|---|---|---|---|---|---|
| | Throat | Zone 1 | Zone 2 | Zone 3 | Zone 4 | Screen | Adaptor |
| | ° F. | ° F. | ° F. | ° F. | ° F. | ° F. | ° F. |
| Skin Layer (I) | 75 | 360 | 420 | 410 | 410 | 410 | 410 |
| Core Layer 1 (H) | 75 | 360 | 420 | 410 | 410 | 410 | 410 |
| Core Layer 2 (G) | 75 | 360 | 420 | 410 | 410 | 410 | 410 |
| Core Layer 3 (F) | 75 | 360 | 420 | 410 | 410 | 410 | 410 |
| Core Layer 4 (E) | 75 | 360 | 420 | 410 | 410 | 410 | 410 |
| Core Layer 5 (D) | 75 | 360 | 420 | 410 | 410 | 410 | 410 |
| Core Layer 6 (C) | 75 | 360 | 420 | 410 | 410 | 410 | 410 |
| Sublayer (B) | 75 | 360 | 420 | 410 | 410 | 410 | 410 |
| Sealant Layer (A) | 75 | 360 | 420 | 410 | 410 | 410 | 410 |

Structure 4 was an A/B/C/D/E/F/G/H/I nine-layer structure having thickness ratios of 13.5%/10%/11%/11%/10%/11%/11.5%/11%/11% in which the sealant layer (A) was prepared from a 48%/32%/18%/2% (by weight) blend of the SSC C2/C8 copolymer 1, the Met. C2/C8 copolymer 2, TOPPYL PB 8640M and the process-aid masterbatch Ingenia 1150. The sublayer B and the core layers C-H in Structure 4 were prepared from a 78%/22% (by weight) blend of the SSC HDPE and the ZN HDPE. The skin layer I in Structure 4 was prepared from a 98%/2% (by weight) blend of ZN HDPE and the process-aid masterbatch Ingenia 1150.

Structure 5 was an A/B/C/D/E/F/G/H/I nine-layer structure having thickness ratios of 15%/10%/12%/13%/10%/13%/12%/10%/5% in which the sealant layer (A) was prepared from a 48%/32%/18%/2% (by weight) blend of the SSC C2/C8 copolymer 1, the Met. C2/C8 copolymer 2, TOPPYL PB 8640M and the process-aid masterbatch Ingenia 1150. The sublayer B and the core layers C-G in Structure 5 were prepared from 100% (by weight) of the SSC HDPE. Core layer H was prepared from 100% (by weight) of the ZN HDPE. The skin layer I in Structure 5 was prepared from a 98%/2% (by weight) blend of ZN HDPE and the process-aid masterbatch Ingenia 1150.

Comparative Structure 3 was an A/B/C/D/E/F/G/H/I nine-layer structure having thickness ratios of 13.5%/10%/11%/11%/10%/11%/11.5%/11%/11% in which the sealant layer (A) was prepared from a 80%/18%/2% (by weight) blend of ULTRATHENE UE624000, TOPPYL PB 8640M and the process-aid masterbatch Ingenia 1150. The sublayer B and the core layers C-G in Comparative Structure 3 were prepared from 100% (by weight) of the SSC HDPE. Core layer H was prepared from 100% (by weight) of the ZN HDPE. The skin layer I in Comparative Structure 3 was prepared from a 98%/2% (by weight) blend of ZN HDPE and the process-aid masterbatch Ingenia 1150.

Structure 6 was an A/B/C/D/E/F/G/H/I nine-layer structure having thickness ratios of 15%/10%/12%/13%/10%/13%/12%/10%/5% in which the sealant layer (A) was prepared from a 48%/32%/18%/2% (by weight) blend of the SSC C2/C8 copolymer 1, the Met. C2/C8 copolymer 2, TOPPYL PB 8640M and the process-aid masterbatch Ingenia 1150. The sublayer B and the core layers C-G in Structure 6 were prepared from a 78%/22% (by weight) blend of the SSC HDPE and the ZN HDPE. The core layer H was prepared from 100% (by weight) of the ZN HDPE. The skin layer I in Structure 6 was prepared from a 98%/2% (by weight) blend of ZN HDPE and the process-aid masterbatch Ingenia 1150.

Structure 7 was an A/B/C/D/E/F/G/H/I nine-layer structure having thickness ratios of 15%/10%/12%/13%/10%/13%/12%/10%/5% in which the sealant layer (A) was prepared from a 48%/32%/18%/2% (by weight) blend of the SSC C2/C8 copolymer 1, the Met. C2/C8 copolymer 2, TOPPYL PB 8640M and the process-aid masterbatch Ingenia 1150. The sublayer B and the core layers C-G in Structure 7 were prepared from 100% (by weight) of the SSC HDPE. Core layer H was prepared from 100% (by weight) of the ZN HDPE. The skin layer I in Structure 7 was prepared from a 98%/2% (by weight) blend of ZN HDPE and the process-aid masterbatch Ingenia 1150.

Comparative Structure 4 was an A/B/C/D/E/F/G/H/I nine-layer structure having thickness ratios of 15%/10%/12%/13%/10%/13%/12%/10%/5% in which the sealant layer (A) was prepared from a 80%/18%/2% (by weight) blend of ULTRATHENE UE624000, TOPPYL PB 8640M and the process-aid masterbatch Ingenia 1150. The sublayer B and the core layers C-G in Comparative Structure 4 were prepared from 100% (by weight) of the SSC HDPE. Core layer H was prepared from 100% (by weight) of the ZN HDPE. The skin layer I in Comparative Structure 4 was prepared from a 98%/2% (by weight) blend of ZN HDPE and the process-aid masterbatch Ingenia 1150.

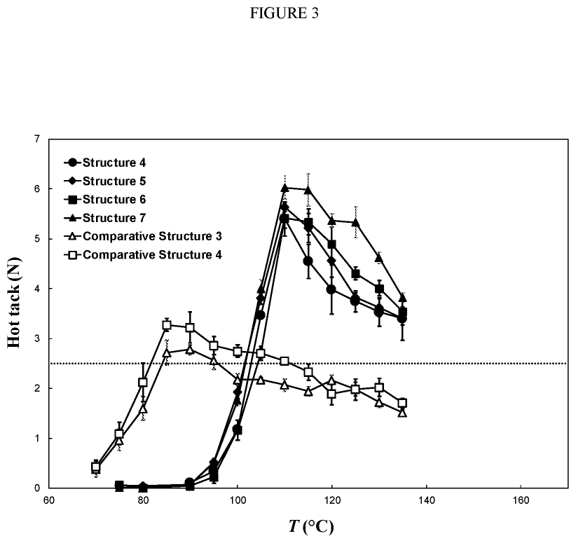

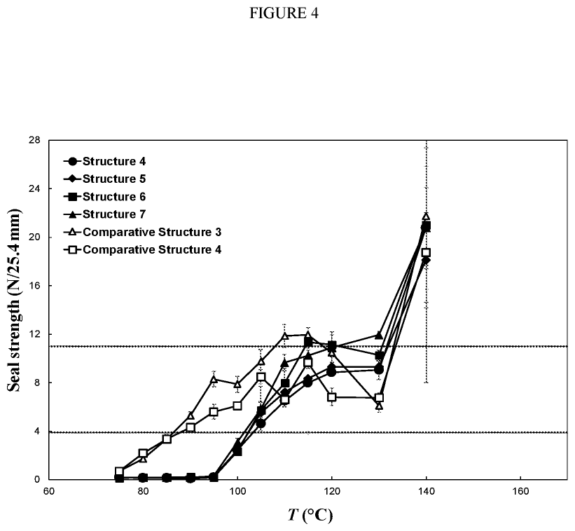

FIG. 3 shows the hot tack profiles for the nine-layer structures prepared in Structures 4-7 and Comparative Structures 3-4. FIG. 4 illustrates the seal strength profiles of the nine-layer structures prepared in Structures 4-7 and Comparative Structures 3-4 conditioned for 24 h under the ASTM conditions.

### INDUSTRIAL APPLICABILITY

The multilayer film structure disclosed herein have industrial applicability in a wide range of manufactured articles wherein at least one component of the manufactured article is formed from the multilayer film structure. A non-limiting example of such manufactured articles include packages.

1. A multilayer film structure, comprising a sealant layer, the sealant layer comprising:
from 5% to 65%, based on the total weight of the sealant layer, of a first ethylene copolymer composition;
from 20% to 90%, based on the total weight of the sealant layer, of a second ethylene copolymer composition; and
from 5% to 30%, based on the total weight of the sealant layer, of a polybutene-1 resin;
wherein the first ethylene copolymer composition has a density of from greater than 0.910 g/cm³ to less than or equal to 0.940 g/cm³ and a melt index 12 of from 3 dg/min to 7 dg/min, and wherein the second ethylene copolymer composition has a density of from greater than or equal to 0.865 g/cm³ to less than or equal to 0.910 g/cm³.

2. The multilayer film structure of claim 1, further comprising a sublayer, the sublayer comprising a high density polyethylene resin having a density of greater than or equal to 0.945 g/cm³ and a melt index I₂ of from 0.1 to 10 dg/min.

3. The multilayer film structure of claim 2, wherein the sublayer is in adhering contact with a bottom surface of the sealant layer.

4. The multilayer film structure of claim 1, wherein the polybutene-1 resin is a butene-1 homopolymer.

5. The multilayer film structure of claim 1, wherein the polybutene-1 resin is a butene-1/ethylene copolymer.

6. The multilayer film structure of claim 1, wherein the sealant layer comprises from 5% to 50%, based on the total weight of the sealant layer, of the first ethylene copolymer composition; from 30% to 90%, based on the total weight of the sealant layer, of the second ethylene copolymer composition; and from 5% to 25%, based on the total weight of the sealant layer, of the polybutene-1 resin.

7. The multilayer film structure of claim 1, wherein the sealant layer comprises from 5% to 50%, based on the total weight of the sealant layer, of the first ethylene copolymer composition; from 30% to 90%, based on the total weight of the sealant layer, of the second ethylene copolymer composition; and from 5% to 20%, based on the total weight of the sealant layer, of the polybutene-1 resin.

8. The multilayer film structure of claim 1, wherein the first ethylene copolymer composition has a melt index I₂ of from 3.5 dg/min to 6 dg/min.

9. The multilayer film structure of claim 1, wherein the first ethylene copolymer composition has a density of from greater than or equal to 0.912 g/cm³ to less than or equal to 0.935 g/cm³.

10. The multilayer film structure of claim 1, wherein the first ethylene copolymer composition has a density of from greater than or equal to 0.912 g/cm³ to less than or equal to 0.930 g/cm³.

11. The multilayer film structure of claim 1, wherein the first ethylene copolymer composition comprises a fraction eluting at a temperature range of from 90° C. to 105° C. having an integrated area of less than or equal to 20 weight percent, in a CTREF analysis.

12. The multilayer film structure of claim 1, wherein the first ethylene copolymer composition contains undetectable levels of long chain branches as determined according to a long chain branching factor, LCBF, of less than 0.001.

13. The multilayer film structure of claim 1, wherein the first ethylene copolymer composition contains detectable levels of long chain branches as determined according to a long chain branching factor, LCBF, of greater than 0.001.

14. The multilayer film structure of claim 1, wherein the first ethylene copolymer composition has a molecular weight distribution M_{w}/Mₙ of greater than or equal to 1.7 to less than or equal to 5.

15. The multilayer film structure of claim 1, wherein the first ethylene copolymer composition is an ethylene/octene-1 copolymer composition.

16. The multilayer film structure of claim 1, wherein the second ethylene copolymer composition has a melt index I₂ of from 0.5 dg/min to 1.5 dg/min.

17. The multilayer film structure of claim 1, wherein the second ethylene copolymer composition has a melt index I₂ of from 0.7 dg/min to 1.2 dg/min.

18. The multilayer film structure of claim 1, wherein the second ethylene copolymer composition has a density of from greater than or equal to 0.890 g/cm³ to less than or equal to 0.910 g/cm³.

19. The multilayer film structure of claim 1, wherein the second ethylene copolymer composition has a density of from greater than or equal to 0.900 g/cm³ to less than or equal to 0.910 g/cm³.

20. The multilayer film structure of claim 1, wherein the second ethylene copolymer composition comprises a fraction eluting at a temperature range of from 90° C. to 105° C. having an integrated area of less than 1 weight percent, in a CTREF analysis.

21. The multilayer film structure of claim 1, wherein the second ethylene copolymer composition has a molecular weight distribution M_{w}/Mₙ of greater than or equal to 1.7 to less than or equal to 4.

22. The multilayer film structure of claim 1, wherein the second ethylene copolymer composition has a molecular weight distribution M_{w}/Mₙ of greater than or equal to 1.7 to less than or equal to 3.5.

23. The multilayer film structure of claim 1, wherein the second ethylene copolymer composition contains detectable levels of long chain branches as determined according to a long chain branching factor, LCBF, of greater than or equal to 0.001.

24. The multilayer film structure of claim 1, wherein the second ethylene copolymer composition is an ethylene/octene-1 copolymer composition.

25. The multilayer film structure of claim 2, wherein the high density polyethylene resin comprises a blend of at least two ethylene homopolymer blend components; the blend comprising:
from 30 to 95 weight percent of a first ethylene homopolymer blend component having a density of from 0.950 to 0.975 g/cm³; and
from 5 to 70 weight parent of a second ethylene homopolymer blend component having a density of from 0.950 to 0.975 g/cm³;
wherein the ratio of the melt index I₂ of the second ethylene homopolymer blend component to the melt index I₂ of the first ethylene homopolymer blend component is at least 10.

26. The multilayer film structure of claim 25, wherein the high density polyethylene resin comprises from 100 to 3000 parts per million of a nucleating agent or a mixture of nucleating agents.

27. The multilayer film structure of claim 25, wherein the high density polyethylene resin has a polydispersity index M_{w}/Mₙ of from 7 to 18.

28. The multilayer film structure of claim 2,
wherein the high density polyethylene resin essentially consists of:
a nucleating agent; and
a blend of two ethylene homopolymer blend components, the blend consists of:
from 30 to 95 weight percent of a first ethylene homopolymer blend component having a density of from 0.950 to 0.975 g/cm³; and
from 5 to 70 weight parent of a second ethylene homopolymer blend component having a density of from 0.950 to 0.975 g/cm³;
wherein the ratio of the melt index I₂ of the second ethylene homopolymer blend component to the melt index I₂ of the first ethylene homopolymer blend component is at least 10.

29. The multilayer film structure of claim 28, wherein the nucleating agent is present in amount from 100 to 3000 parts per million.

30. The multilayer film structure of claim 28, wherein the high density polyethylene resin has a polydispersity index M_{w}/Mₙ of from 7 to 18.

31. The multilayer film structure of claim 1, wherein the multilayer film has from 3 to 11 layers.

32. The multilayer film structure of claim 1, wherein the multilayer film structure is an all-polyethylene multilayer film structure.

33. The multilayer film structure of claim 1, wherein the multilayer film structure has a seal initiation temperature, SIT, of less than or equal to 115° C., wherein SIT is the minimum sealing temperature at which the film structure has a seal strength of greater than 3.9 N per 25.4 mm of seal width.

34. The multilayer film structure of claim 1, wherein the multilayer film structure has a hot tack onset temperature of less than or equal to 110° C., wherein the hot tack onset temperature is the minimum sealing temperature at which the film structure has a hot tack force of greater than 1.0 N.

35. The multilayer film structure of claim 1, wherein the multilayer film structure has a hot tack window of greater than or equal to 20° C., wherein the hot tack window is a range of sealing temperature in which the multilayer film structure has a hot tack force of greater than 2.5 N.

36. The multilayer film structure of claim 33, wherein the multilayer film structure has a seal strength of less than 11 N per 25.4 mm of seal width at a at a sealing temperature of from SIT to SIT+25° C.

37. A package comprising the multilayer film structure of claim 1.

38. The package of claim 37, wherein a first section of a top surface of the sealant layer is heat sealed to a second section of the top surface of the sealant layer to form a peelable seal.

39. The package of claim 38, wherein the peelable seal has a peel initiation force of from 2 N to 15 N at a sealing temperature of from 110° C. to 125° C.

40. The package of claim 38, wherein the peelable seal has a peel propagation force of from 1 N to 6 N at a sealing temperature of from 110° C. to 125° C.

41. The package of claim 37, wherein the package further comprises a tray, and wherein a first section of a top surface of the sealant layer is heat sealed to the tray to form a peelable seal.
